(19) United States
(12) Patent Application Publication
(10) Pub. No.: US 2025/0068148 A1
(43) Pub. Date: Feb. 27, 2025

(54) DEVICE PROCESSING METHOD, COMPUTER DEVICE, AND READABLE STORAGE MEDIUM

(71) Applicant: LUMI UNITED TECHNOLOGY CO., LTD., Shenzhen (CN)

(72) Inventors: Huifang WU, Shenzhen (CN); Long ZHANG, Shenzhen (CN); Lu HUANG, Shenzhen (CN); Xiaoyi TANG, Shenzhen (CN)

(73) Assignee: Lumi United Technology Co., Ltd., Shenzhen (CN)

(21) Appl. No.: 18/942,812

(22) Filed: Nov. 11, 2024

Related U.S. Application Data
(63) Continuation-in-part of application No. PCT/CN2023/092301, filed on May 5, 2023.
(63) Continuation-in-part of application No. PCT/CN2023/095254, filed on May 19, 2023.
(63) Continuation-in-part of application No. PCT/CN2024/091493, filed on May 7, 2024.

(30) Foreign Application Priority Data
May 11, 2022 (CN) 202210532411.X
May 23, 2022 (CN) 202210565079.7
May 8, 2023 (CN) 202310511468.6

(51) Int. Cl. G05B 19/418

(52) U.S. Cl. CPC G05B 19/41865; G05B 2219/2642

(57) ABSTRACT

A device processing method and system, and a computer device and a readable storage medium. The method includes: upon acquiring configuration recommendation information for a device in a target space, which information is obtained by means of performing analysis on the basis of historical device operation data, pushing and displaying the device configuration recommendation information; in response to a selection operation for at least one device configuration item, the terminal device displaying device control information corresponding to a selected target device configuration item; and in response to a configuration operation for the selected target device configuration item, performing configuration processing on a corresponding device on the basis of the target device configuration item, wherein the device configuration item is generated according to the historical device operation data. In this way, the usage habits of the user are better adapted to, and can reduce the difficulty in automatic instruction configuration.

### CROSS REFERENCE TO RELATED APPLICATIONS

The present disclosure is a continuation-in-part of International (PCT) Patent Application PCT/CN2023/095254 filed on May 19, 2023, International (PCT) Patent Application PCT/CN2023/092301 filed on May 5, 2023, and International (PCT) Patent Application PCT/CN2024/091493 filed on May 7, 2024, which respectively claim priority to Chinese Patent Application CN2022105650797 filed on May 23, 2022, Chinese Patent Application CN202210532411X filed on May 11, 2022, and Chinese Patent Application CN2023105114686 filed on May 8, 2023. The entire content of the aforementioned applications is hereby incorporated by reference.

### TECHNICAL FIELD

The present disclosure relates to the technical field of smart home technology, and in particular, the present disclosure relates to a device processing method, computer device, and readable storage medium.

### BACKGROUND

Smart devices have been widely used in various scenes, including home and other settings. Taking smart homes as an example, one of the core functions of smart homes is to automatically control smart devices, thereby achieving the goal of smart homes and enhancing the experience of home living.

Smart devices need to be configured for some control operations that they will perform automatically. Users can configure smart devices according to their own habits. For users who are new to smart homes, they may not understand the rules of smart device configuration, which makes it difficult to actively carry out automated configuration. For experienced users, their configured instructions may also deviate from their actual living habits.

### SUMMARY OF THE DISCLOSURE

According to a first aspect, an embodiment provides, a device processing method, includes: when obtaining device configuration recommendation information for a device under a target space, pushing and displaying the device configuration recommendation information; wherein the device configuration recommendation information is obtained by analyzing a historical device operation data: responding to a selection operation for at least one device configuration item in the device configuration recommendation information, displaying device control information corresponding to a selected target device configuration item; responding to a configuration operation for the selected target device configuration item, performing configuration processing on the corresponding device based on a target device configuration item, to apply the target device configuration item.

In one embodiment, wherein the device configuration recommendation information includes a scene configuration plan for a target scene: before when obtaining the device configuration recommendation information for the device under the target space, pushing and displaying the device configuration recommendation information, the method includes: obtaining the historical device operation data, wherein the historical device operation data records at least operating attribute of the device: wherein the operating attribute is used to indicate at least one of an action performed by the device, a state after the device performs the action, and a time when the device performs the action: determining device configuration requirement for the target scene based on the operating attribute of the device recorded in the historical device operation data: the device configuration requirement is used to indicate that at least one device needs to configure corresponding action in the target scene: generating the scene configuration plan for the target scene according to the device configuration requirement, so that at least one device performs corresponding action configured according to the scene configuration plan in the target scene, when the target scene is executed.

In one embodiment, wherein the device configuration recommendation information includes a device control command corresponding to a target scene: after performing configuration processing on the corresponding device based on the target device configuration item, to apply the target device configuration item, the method further includes: obtaining a first device parameter of a configured target scene, wherein the first device parameter is generated when the smart device executing an initial action configured in the target scene: obtaining a scene steady-state set of the target scene, wherein the scene steady-state set includes second device parameters generated during multiple scene observation periods: wherein each second device parameter is generated when the smart device executing an additional action during a single scene observation period: updating the device control command when the target scene is triggered based on the first device parameter and the second device parameters in the scene steady-state set: wherein the device control command is used to indicate the smart device to execute corresponding initial action.

According to a second aspect, an embodiment provides a device configuration system, the system including: a server, configured to analyze a historical device operation data to obtain device configuration recommendation information, and to send the device configuration recommendation information to a terminal device: the terminal device, configured to push and display the device configuration recommendation information when obtaining the device configuration recommendation information for a device under a target space: respond to a selection operation for at least one device configuration item in the device configuration recommendation information, display device control information corresponding to a selected target device configuration item; and respond to a configuration operation for the selected target device configuration item, perform configuration processing on the corresponding device based on a target device configuration item, to apply the target device configuration item.

According to a third aspect, an embodiment provides a device configuration apparatus, the apparatus including: a pushing module, configured to push and display device configuration recommendation information when obtaining the device configuration recommendation information for a device under a target: wherein the device configuration recommendation information is obtained by analyzing a historical device operation data: a displaying module, configured to display device control information corresponding to a selected target device configuration item, respond to a selection operation for at least one device configuration item in the device configuration recommendation information: a configuration module, configured to perform configuration processing on a corresponding device based on a target device configuration item in response to a configuration operation for a selected target device configuration item, to apply the target device configuration item.

According to a fourth aspect, an embodiment provides a device processing method, includes: obtaining the historical device operation data, wherein the historical device operation data records at least operating attribute of the device: wherein the operating attribute is used to indicate at least one of an action performed by the device, a state after the device performs the action, and a time when the device performs the action: determining device configuration requirement for the target scene based on the operating attribute of the device recorded in the historical device operation data: the device configuration requirement is used to indicate that at least one device needs to configure corresponding action in the target scene: generating the scene configuration plan for the target scene according to the device configuration requirement, so that at least one device performs corresponding action configured according to the scene configuration plan in the target scene, when the target scene is executed.

According to a fifth aspect, an embodiment provides a device processing device, includes: a log obtaining module, used for obtaining the historical device operation data, wherein the historical device operation data records at least operating attribute of the device; wherein the operating attribute is used to indicate at least one of an action performed by the device, a state after the device performs the action, and a time when the device performs the action: a requirement determination module, used for determining device configuration requirement for the target scene based on the operating attribute of the device recorded in the historical device operation data: the device configuration requirement is used to indicate that at least one device needs to configure corresponding action in the target scene: a plan generation module, used for generating the scene configuration plan for the target scene according to the device configuration requirement, so that at least one device performs corresponding action configured according to the scene configuration plan in the target scene, when the target scene is executed.

According to a sixth aspect, an embodiment provides a device processing method executed by a control terminal, the method includes: obtaining a first device parameter of a target scene, wherein the first device parameter is generated when the smart device executing an initial action configured in the target scene; obtaining a scene steady-state set of the target scene, wherein the scene steady-state set includes second device parameters generated during multiple scene observation periods; wherein each second device parameter is generated when the smart device executing an additional action during a single scene observation period; updating the device control command when the target scene is triggered based on the first device parameter and the second device parameters in the scene steady-state set; wherein the device control command is used to indicate the smart device to execute corresponding initial action.

According to a seventh aspect, an embodiment provides a device processing device, the device includes: a first device parameter obtaining module, used for obtaining a first device parameter of a target scene, wherein the first device parameter is generated when the smart device executing an initial action configured in the target scene; a second parameter obtaining module, used for obtaining a scene steady-state set of the target scene, wherein the scene steady-state set includes second device parameters generated during multiple scene observation periods; wherein each second device parameter is generated when the smart device executing an additional action during a single scene observation period: an instruction updating module, used for updating the device control command when the target scene is triggered based on the first device parameter and the second device parameters in the scene steady-state set; wherein the device control command is used to indicate the smart device to execute corresponding initial action.

According to an eighth aspect, an embodiment provides a device processing method, executed by a user terminal, the method includes: displaying an instruction optimization data for the target scene, wherein the instruction optimization data is used to indicate an updated device control command: the updated device control command is determined by the control terminal based on a first device parameter of the target scene and second device parameters in a scene steady-state set; the first device parameter is generated by the smart device executing an initial action configured in the target scene, indicating a device state of the smart device; wherein the scene steady-state set includes the second device parameters generated during multiple scene observation periods; each second device parameter is generated by the smart device an executing additional action during a single scene observation period; sending a confirmation message to the control terminal in response to a confirmation operation triggered by the instruction optimization data, so that the control terminal updates the device control command when the target scene is triggered.

According to a ninth aspect, an embodiment provides a device processing device, the device includes: a data displaying module, used for displaying an instruction optimization data for the target scene, wherein the instruction optimization data is used to indicate an updated device control command; the updated device control command is determined by the control terminal based on a first device parameter of the target scene and second device parameters in a scene steady-state set; the first device parameter is generated by the smart device executing an initial action configured in the target scene, indicating a device state of the smart device; wherein the scene steady-state set includes the second device parameters generated during multiple scene observation periods; each second device parameter is generated by the smart device an executing additional action during a single scene observation period; a message sending module, used for sending a confirmation message to the control terminal in response to a confirmation operation triggered by the instruction optimization data, so that the control terminal updates the device control command when the target scene is triggered.

According to a tenth aspect, an embodiment provides a computer device, including at least one memory and at least one processor, the memory storing computer-readable instructions, the computer-readable instructions is configured to be executed by the processor, and cause the computer device to perform the method of one or more embodiments.

According to a eleventh aspect, an embodiment provides computer-readable storage medium, storing computer-readable instructions, the computer-readable instructions is configured to be executed by one or more processors, and cause the one or more processors to perform the method of one or more embodiments.

According to a twelfth aspect, an embodiment provides a computer program product or a computer program, which includes computer-readable instructions stored on a computer-readable storage medium: a processor of a computer device reads the computer-readable instructions from the computer-readable storage medium and executes the computer-readable instructions to implement the steps of the device processing method in the various embodiments of the present application.

### BRIEF DESCRIPTION OF THE DRAWINGS

In order to explain technical solutions in embodiments of the present disclosure in more clearly, drawings required to be used in description of the embodiments of the present disclosure will be briefly introduced below. It is obvious that the drawings in the following description are only some embodiments of the present disclosure. For one of ordinary skill in the art, other drawings can be further obtained according to these drawings on the premise of paying no creative work.

FIG. 1 is a schematic diagram of a smart home system architecture provided in an embodiment of the present application;

FIG. 2 is a flow diagram of a device processing method provided in an embodiment of the present application;

FIG. 3A is a schematic diagram of an application interface provided in an embodiment of the present application;

FIG. 3B is a schematic diagram of a notification message display interface provided in an embodiment of the present application;

FIG. 3C is a schematic diagram of a device configuration item list provided in an embodiment of the present application;

FIG. 3D is a schematic diagram of a device configuration item configuration interface provided in an embodiment of the present application;

FIG. 4 is a flow diagram of a method for generating device configuration items provided in an embodiment of the present application;

FIG. 5 is a system data flow diagram provided in an embodiment of the present application;

FIG. 6 is a schematic diagram illustrating the differences between the device processing method provided in an embodiment of the present application and existing technology;

FIG. 7 is a schematic diagram illustrating the interaction between the smart device and the server terminal in the implementation environment shown in FIG. 1;

FIG. 8 is a flowchart of a device processing method according to an exemplary embodiment;

FIG. 9 is a flowchart of step 330 in the embodiment corresponding to FIG. 8 in one embodiment;

FIG. 10 is a flowchart of step 330 in the embodiment corresponding to FIG. 8 in another embodiment;

FIG. 11 is a schematic diagram illustrating the generation of a scene configuration plan based on device configuration requirements according to an exemplary embodiment;

FIG. 12 is a flowchart of another device processing method according to an exemplary embodiment;

FIG. 13 is a schematic diagram illustrating the pushing of configuration prompt information to users in the embodiment corresponding to FIG. 12;

FIGS. 14 to 16 are sequence diagrams of a device processing method in an application scene;

FIG. 17 is a flowchart of a device processing method according to an exemplary embodiment;

FIG. 18 is a flowchart of a command update method according to an exemplary embodiment;

FIG. 19 is a flowchart of another device processing method according to an exemplary embodiment;

FIG. 20 is a schematic diagram illustrating the specific implementation of a device processing method in an application scene;

FIG. 21 is a structural block diagram of a device processing apparatus according to an exemplary embodiment;

FIG. 22 is a schematic diagram of the structure of a computer device provided in an embodiment of the present application;

FIG. 23 is a schematic diagram of the structure of another computer device provided in an embodiment of the present application.

### DETAILED DESCRIPTION

Further detailed description of the present application will be provided through specific embodiments in conjunction with the accompanying drawings. In different embodiments, similar components are designated with corresponding reference numbers. Many of the detailed descriptions provided below are intended to enable a better understanding of the present application. However, those skilled in the art will readily recognize that some features can be omitted or replaced by other components, materials, or methods under different circumstances. In some cases, certain operations related to the present application are not shown or described in the specification in order to avoid overwhelming the core aspects of the application with excessive details. For those skilled in the art, a detailed description of these operations is not necessary; as they can fully understand the relevant operations based on the description in the specification and general technical knowledge in the field.

Additionally, the features, operations, or characteristics described in the specification can be combined in any appropriate manner to form various embodiments. At the same time, the steps or actions described in the method can be rearranged or adjusted in a manner that is apparent to those skilled in the field. Therefore, the various orders in the specification and drawings are only for the purpose of clearly describing a particular embodiment and do not necessarily represent the required order, unless otherwise specified that a particular order must be followed.

The serial numbers assigned to components in this text, such as “first,” “second,” etc., are used solely to distinguish the described objects and do not have any order or technical significance. The terms “connected” or “coupled,” as used in this application, unless otherwise specified, include both direct and indirect connections.

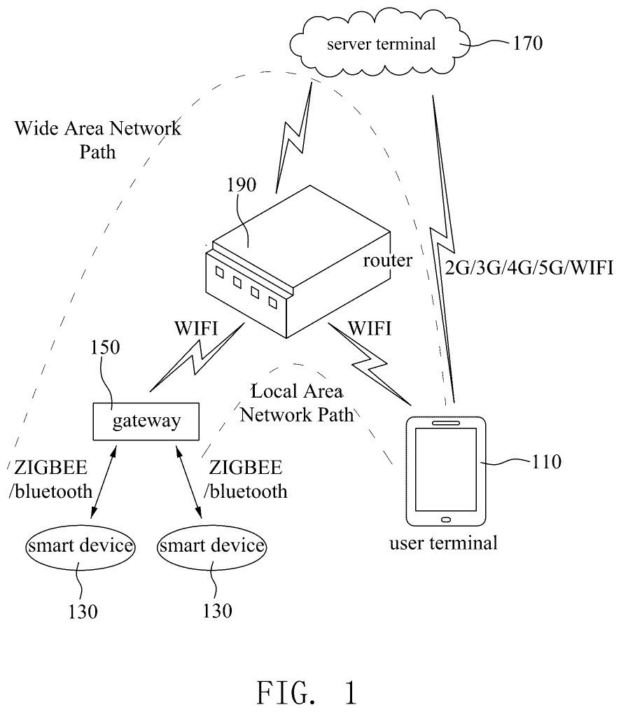

The method for configuration smart devices provided in this application can be applied to the application environment shown in FIG. 1. An exemplary illustration will be provided using a smart home system as the application environment.

Please refer to FIG. 1, which is an architectural diagram of a smart home system provided in an embodiment of the present application. The smart home system can include: a terminal device 110 and some smart devices 130, Wherein, the terminal device can, but is not limited to, being the user terminal 110. The diagram illustratively shows two smart devices 130. The user terminal 110 communicates with the smart devices, and different smart devices may or may not be connected to each other.

Additionally, the system for configuration smart devices can also include a server terminal (alternatively referred to as a server) 170. The server terminal 170 can receive data sent by smart devices and/or user terminal 110 and can be implemented using a standalone server or a server cluster composed of multiple servers.

Furthermore, for the smart home system, a voice device can also be included, which is used for voice interaction with the user, thereby controlling the smart devices based on the received voice commands.

The voice device can be the user terminal 110, or it can be a separate interactive device with voice interaction capabilities, such as a smart control panel with voice interaction features.

Furthermore, in one embodiment, the smart home system may also include a gateway 150, a server terminal 170, and a router 190.

Specifically, the user terminal 110, which can also be considered as a user end or terminal, can deploy (also understood as install) a client associated with the smart device 130. This user terminal 110 can be a smartphone, tablet computer, laptop computer, desktop computer, smart control panel, or other electronic devices with display and control functions, without limitation.

In which, the client in the user terminal 110 is associated with the smart device 130. Essentially, it means that the user registers an account in the client and configures the smart device 130 in the client. For example, the configuration includes adding device identifiers for the smart device 130, so that when the client is running in the user terminal 110, it can provide the user with functions such as device display and device control for the smart device 130. This client can be in the form of an application or a web page, and accordingly, the interface for display and control by the client can be in the form of a program window or a web page, without limitation.

The smart device 130 is deployed in the gateway 150 and communicates with the gateway 150 through its own configured communication module, thereby being controlled by the gateway 150. It should be understood that the smart device 130 generally refers to one of multiple smart devices 130. This embodiment only uses the smart device 130 as an example for illustration, that is to say, this embodiment does not limit the number and type of smart devices deployed in the gateway 150. In one application scene, the smart device 130 accesses the gateway 150 through a local area network, thereby being deployed in the gateway 150. The process of the smart device 130 accessing the gateway 150 through a local area network includes: the gateway 150 first establishes a local area network, and the smart device 130 connects to the gateway 150, thereby joining the local area network established by the gateway 150. This local area network includes but is not limited to: ZIGBEE or Bluetooth. The smart device 130 can be a smart printer, smart fax machine, smart camera, smart air conditioner, smart door lock, smart light, or electronic devices with communication modules such as human body sensors, door and window sensors, temperature and humidity sensors, water immersion sensors, natural gas alarms, smoke alarms, wall switches, wall sockets, wireless switches, wireless wall switch stickers, Rubik's cube controllers, curtain motors, etc.

The interaction between the user terminal 110 and the smart device 130, for example, the user uses the user terminal 110 to execute a scene with one click to control the smart device 130 to perform the configured actions in that scene, can be implemented through a local area network or a wide area network. In one application scene, the user terminal 110 establishes a wired or wireless communication connection with the gateway 150 through the router 190, for example, this wired or wireless method includes but is not limited to WIFI, etc., enabling the user terminal 110 and the gateway 150 to be deployed in the same local area network, thereby enabling the user terminal 110 to interact with the smart device 130 through a local area network path. In another application scene, the user terminal 110 establishes a wired or wireless communication connection with the gateway 150 through the server terminal 170, for example, this wired or wireless method includes but is not limited to 2G, 3G, 4G, 5G, WIFI, etc., enabling the user terminal 110 and the gateway 150 to be deployed in the same wide area network, thereby enabling the user terminal 110 to interact with the smart device 130 through a wide area network path.

In one application scene, the user terminal 110 can be used to control or manage smart devices with networking capabilities. For example, the user terminal 110 can have an application (Application, referred to as APP) installed, which can be a smart home application. When the smart home application is running, it can push device configuration recommendation information for smart devices in the smart home system. The user terminal 110 displays at least one device configuration item generated based on the user's usage data within a preset time period, based on the user's selection operation for the recommended configuration prompt information. The device configuration item is obtained by analyzing historical device operation data and conforms to the user's usage habits. The device configuration item can be obtained by analyzing the historical device operation data of devices under the target space by the user terminal 110 or the server terminal 170. Based on the selection operation for the device configuration item, the corresponding device is configured and processed based on the target device configuration item, thereby applying the target device configuration item, achieving rapid configuration of smart devices, configuration smart devices based on the user's independent choice, making the device configuration more in line with user needs, and improving the user experience.

In one application scene, the device configuration recommendation information includes a scene configuration plan for the target scene; the user terminal 110 obtains device operation data, which records at least the operating attributes of the device; the operating attributes are used to indicate at least one of the actions performed by the device, the state after the device performs the action, and the time when the device performs the action; based on the operating attributes of the device recorded in the device operation data, the device configuration requirements for the target scene are determined; the device configuration requirements are used to indicate that at least one device needs to configure corresponding actions in the target scene; a scene configuration plan is generated for the target scene based on the device configuration requirements, so that at least one device performs corresponding actions configured according to the scene configuration plan in the target scene when the target scene is executed.

In one application scene, after applying the target device configuration items corresponding to the device configuration recommendation information, the device control commands corresponding to the configured target scene can be obtained. The user terminal 110 or the server terminal 170 obtains the first device parameter of the configured target scene and the scene steady-state value: among them, the first device parameter is generated by the smart device executing the initial action configured in the target scene; the scene steady-state set includes the second device parameters generated during multiple scene observation periods, and the second device parameters are generated by the smart device executing additional actions during a single scene observation period; then the user terminal 110 or the server terminal 170 updates the device control commands triggered by the target scene based on the first device parameter and the second device parameters in the scene steady-state set.

In another application scene, the user terminal 110 displays the optimized instruction data of the configured target scene to show the updated device control commands to the user. If the user confirms the instruction optimization, the user terminal 110 sends a confirmation message to the server terminal 170, causing the server terminal 170 to update the device control commands triggered by the target scene.

Below is a detailed description of the technical solution of the present application through a specific embodiment.

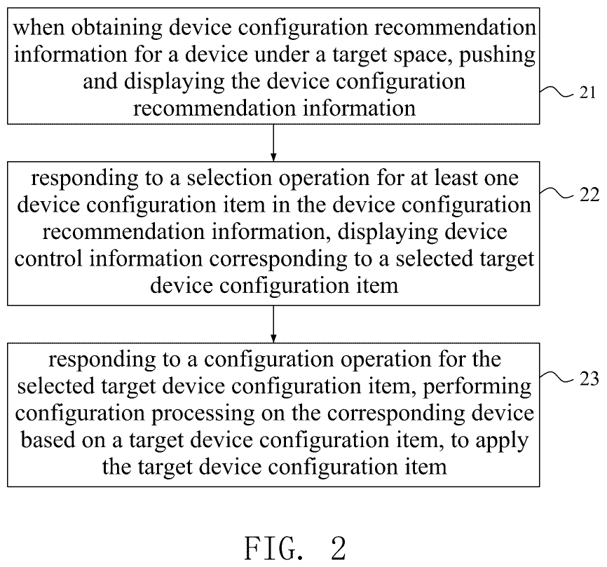

Please refer to FIG. 2, which is a flow diagram of a device processing method provided in an embodiment of the present application. The method provided in this embodiment is executed by a computer device, which can be the user terminal device 110 shown in the aforementioned FIG. 1, or it can also be a smart device with control functions such as a smart control panel. The method provided in this embodiment can be applied to an Internet of Things (IoT) system, which can be the system shown in the aforementioned FIG. 1.

The method provided in this embodiment can include the following steps 21-23:

Step 21: when obtaining device configuration recommendation information for a device under a target space, pushing and displaying the device configuration recommendation information.

Wherein, the target space is the real space where the devices in the IoT system are located. For example, when a smart home system is installed in a residence, the smart devices within the residence can be connected to the smart home system, and the residence is the target space. Devices under the target space can be smart devices that the terminal device can control, such as the smart devices shown in FIG. 1.

The device configuration recommendation information can refer to suggestions for configuration smart devices. This information is analyzed and obtained by the terminal device or server based on historical device operation data. It can be understood that the device configuration recommendation information is automatically generated and can serve as a reference for users configuration smart devices.

The device configuration recommendation information is derived from the analysis of historical device operation data. It can be understood that historical device operation data refers to the operational data of various smart devices over a period of time, which can be specifically obtained through the operation logs of the respective smart devices.

The terminal device obtains the device configuration recommendation information for the smart devices in the smart home system and pushes and displays this information. For example, the device configuration recommendation information can be displayed on the screen of the terminal device, or it can be shown on the interface of an application running on the terminal device, allowing users to view the device configuration recommendation information.

Step 22: responding to a selection operation for at least one device configuration item in the device configuration recommendation information, displaying device control information corresponding to a selected target device configuration item.

Wherein, the device configuration recommendation information includes at least one device configuration item. A device configuration item refers to configuration information regarding various attributes of a smart device, enabling users to understand what settings can be applied to that smart device.

When there are multiple device configuration items, all device configuration items can be displayed in the form of a list or stack, and the present application does not limit the display form of the device configuration items.

The selection operation can take various forms, such as a click operation or a voice command, for example, a voice input saying “I want to view the first device configuration item” or “Display the first device configuration item,” and the present application does not limit this to specific forms.

The device control information refers to the control information recommended for setting on the smart device.

For example, the device control information can include the target device and the target control operation and target execution time for the target device. The target control operation for the smart device can be to turn on, adjust, or turn off the smart device, etc. For instance, when the smart device is an intelligent curtain, the control operation for the smart device can be to open the intelligent curtain by 50%, fully open the intelligent curtain, or close the intelligent curtain, etc.

The terminal device, based on the received selection operation for at least one device configuration item in the device configuration recommendation information, displays the control information for the selected target device configuration item corresponding to the target device.

Step 23: responding to a configuration operation for the selected target device configuration item, performing configuration processing on the corresponding device based on a target device configuration item, to apply the target device configuration item.

Wherein, the configuration operation can include modifying, deleting, or confirming the target device configuration item.

The terminal device responds to a configuration operation for the selected target device configuration item by performing a confirmation operation on at least one of the device configuration items for the smart device, and configures the smart device corresponding to the target device configuration item based on the target device configuration item.

After receiving a configuration operation from the user for the target device configuration item, the terminal device configures the corresponding target device according to the user-confirmed target device configuration item. For example, the terminal device applies the control operation and its execution parameters from the target device configuration item to the target device. For instance, when the control operation in the target device configuration item is to open the curtains and the execution time is set for 7 AM daily, then the curtains are configured to open automatically at 7 AM every day:

Wherein, the target device configuration item can be one or more of the device configuration items for the smart device.

In this embodiment, when the terminal device obtains configuration recommendation information for devices under the target space, which is based on the analysis of historical device operation data, then it pushes and displays the device configuration recommendation information, allowing users to promptly see that there are new configuration recommendations. The terminal device responds to a selection operation for at least one device configuration item in the device configuration recommendation information by displaying the device control information corresponding to the selected target device configuration item, enabling users to view, modify, and confirm the device control information corresponding to the selected target device configuration item through configuration operations. Responding to a configuration operation for the selected target device configuration item, the terminal device configures the corresponding device based on the target device configuration item to apply the target device configuration item. The configuration recommendation information, which is derived from the analysis of historical device operation data, can effectively mine users' needs for automated command configuration, making the device configuration items more in line with users' usage habits. By configuration smart devices based on user choices and allowing users to voluntarily configure smart devices, the device configuration is more tailored to user needs, enhancing the fit between automated services and users' actual lives.

Additionally, this saves the time users would spend on their own configuration, making the device configuration more aligned with the actual usage situations of the users. Furthermore, while users would need to answer quiz questions during self-configuration, the method in this embodiment already provides device configuration items as a reference for user configuration, allowing users to directly determine whether to execute them. Therefore, the method in this embodiment transforms quiz questions into judgment questions, significantly reducing the difficulty of configuration automated commands and improving the user experience.

In some embodiments, based on the embodiment shown in FIG. 2, step 21 can further include the following steps:

Step 211: when obtaining the device configuration recommendation information for the device under the target space, pushing and displaying a recommendation configuration prompt information corresponding to the device configuration recommendation information.

Wherein, the recommendation configuration prompt information is configured to prompt users to view the device configuration recommendation information. For example, it can display the number of device configuration items included in the device configuration recommendation information without including the specific device configuration items. For instance, the recommendation configuration prompt information could display: “You have 3 new configuration suggestions” or “Please check out the 2 automation suggestions generated for you,” etc.

The recommendation configuration prompt information can take various forms. For example, it can be displayed as a scrolling notification or in the form of a dialog box.

The terminal device can push the recommendation configuration prompt information in various ways. For instance, the terminal device can push the recommendation configuration prompt information in areas such as system notifications, or during the operation of an application, on the displayed application interface.

The application interface is the display interface when the application is running, which can be the home page of the application or other pages within the application.

Furthermore, the recommendation configuration prompt information can also be configured to display other notification messages of the application. When displaying other notification messages of the application, the prompt information for configuration suggestions and other notification messages can be displayed in a scrolling loop.

Step 212: responding to a selection operation received for the recommendation configuration prompt information, displaying the device configuration recommendation information.

When the user wishes to view the recommendation message, they can select the recommendation configuration prompt information, thereby causing the terminal device to display the device configuration items that the user has not yet viewed, based on the received selection operation.

The selection operation on the recommendation configuration prompt information can take various forms. For example, it can be a click operation on the recommendation configuration prompt information, or a voice command such as “I want to view configuration suggestions” or “Display configuration suggestions,” and this application does not limit these forms.

In this embodiment, the terminal device, upon obtaining the device configuration recommendation information for devices under the target space, can push the recommendation configuration prompt information. The terminal device displays the device configuration recommendation information based on the user's selection operation for the recommendation configuration prompt information, thereby promptly alerting the user to view new device configuration recommendation information and enhancing the user experience.

Furthermore, step 211 can be implemented through the following steps:
responding to an application launch command, launching the application and displaying the recommendation configuration prompt information on the home page of the application.

The home page of the application is the first interactive interface displayed after the application is launched.

After the application in the terminal device is launched, the recommendation configuration prompt information is displayed on the home page, allowing users to immediately learn about a new device configuration item.

Optionally; when the processor is located on the server, that is, when the device configuration recommendation information is generated by the server, then after the application is launched, the terminal device obtains the latest device configuration items from the server and generates recommendation configuration prompt information based on the obtained device configuration items.

In this embodiment, after the application is launched, the terminal device displays recommendation configuration prompt information on the home page of the application. After the user opens the application, regardless of the operation they wish to perform, they can first pay attention to the content prompted in the recommendation configuration prompt information, allowing the user to promptly view the corresponding device configuration items and serving as an effective guidance.

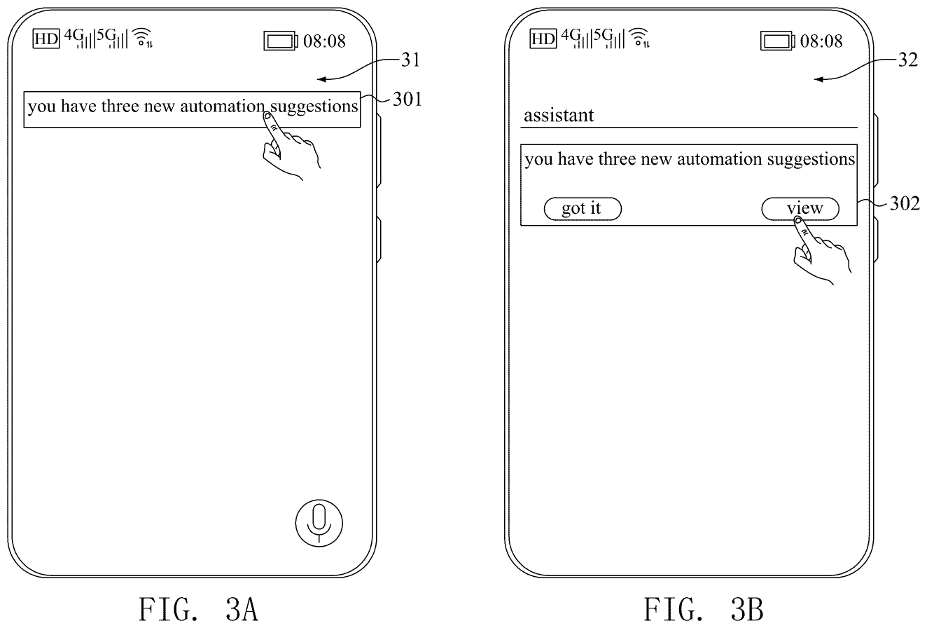

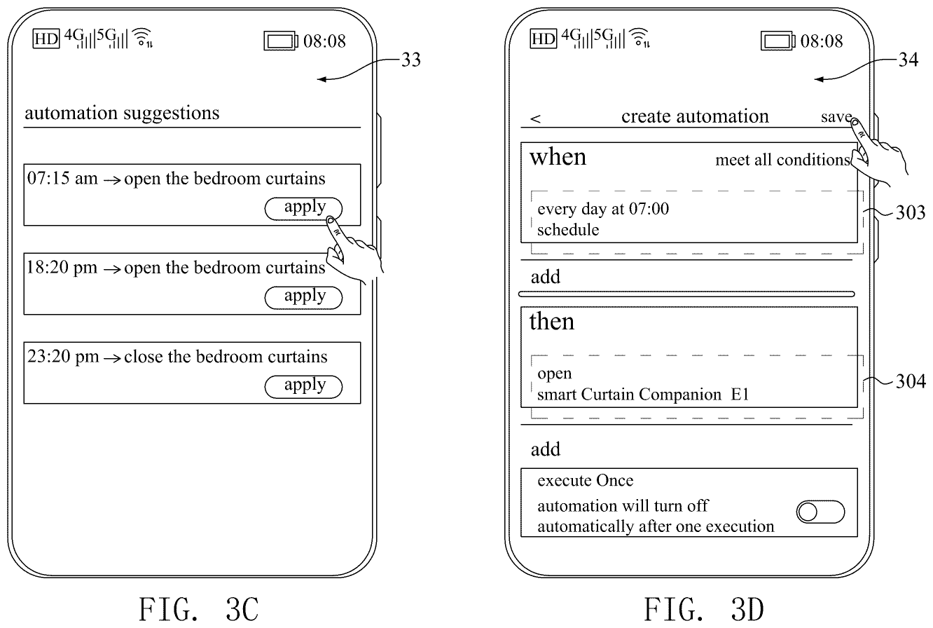

Below, FIGS. 3A-3D are used as examples to illustrate the method provided in this embodiment of the application. It is understood that FIGS. 3A-3D are merely one specific form of implementation exemplarily shown for the purpose of illustrating the method provided in this embodiment of the application, and they do not constitute a limitation on this application. The automation suggestions in FIGS. 3A-3D correspond to the configuration suggestions in this application.

Please refer to FIG. 3A, which is a schematic diagram of an application interface provided in this embodiment of the application. The application interface 31 includes recommendation configuration prompt information 301.

The user can click on the recommendation configuration prompt information 301, and the interface will switch from interface 31 to the interface 32 shown in FIG. 3B. Please refer to FIG. 3B, which is a schematic diagram of a notification message display interface provided in this embodiment of the application. Interface 32 can be a display interface for all notification messages of the application, which can be displayed in a list form (other notification messages are not shown in FIG. 3B), including an interactive control 302 for the recommendation configuration prompt information 301. In 302, the user clicks “Got it,” and the recommendation suggestion prompt information for those three device configuration items will no longer be displayed. When the user clicks “View,” interface 32 can switch to interface 33 shown in FIG. 3C.

Please refer to FIG. 3C, which is a schematic diagram of a device configuration item list provided in this embodiment of the application. Interface 33 can display the content of specific device configuration items in a list form. The user clicks “Apply” corresponding to the device configuration item, and the interface will switch from interface 33 to interface 34 shown in FIG. 3D.

Please refer to FIG. 3D, which is a schematic diagram of a device configuration item configuration interface provided in this embodiment of the application. Interface 34 displays the specific implementation form of the device configuration item. Interface 34 can be similar to the interface for creating a new device configuration item, except that the control operation 304 and the control operation execution time 303 have already been pre-filled according to the device configuration item. The user can click “Save” to save the corresponding device configuration item, thereby configuration the corresponding smart device based on the save confirmation operation.

In some scenes, the terminal device can also be a device with voice interaction capabilities, such as a smart control panel with voice interaction capabilities. Below is an illustration using a smart control panel as the terminal device. During the operation of the smart home system, users can control or manage smart devices through a smart home application installed on their mobile phone, or through voice interaction with a smart control panel. Users usually prefer to control smart devices using the smart control panel for simple control processes, reducing the number of times they open the application. Therefore, after a new device configuration item is generated, when the user has not opened the application but interacts with the smart control panel through voice, the recommendation configuration prompt information can be output through the smart control panel. Specific examples are provided below.

Based on the embodiment shown in FIG. 2, further, before step 21, the following steps can also be included:
after completing a voice interaction, detecting whether there are any device configuration items that have not been viewed currently.

If so, output a voice prompt message.

The voice device determines that there are device configuration items that the user has not viewed in the application currently and outputs a voice prompt message.

Wherein, voice interaction is the interaction process between the user and the voice device. For example, it can be the user waking up the voice device and asking the voice device to turn on the TV.

The voice prompt information is configured to remind users to view the device configuration items. The voice prompt information can take various forms, for example, it can be “Please view the new configuration suggestions in the APP” or “You have new configuration suggestions, please view them in the APP promptly;” etc.

In this embodiment, after the terminal device completes a voice interaction, it determines whether there are any device configuration items that the user has not viewed currently. When there are, it outputs voice prompt information. When not, it continues with the original processing procedure. This allows the terminal device to promptly remind the user through the terminal device even when the user does not frequently open the terminal device. Additionally, the voice prompt information is output after the voice device completes a control interaction, ensuring that the user control interaction proceeds normally while also reminding the user to view new device configuration items promptly, thereby enhancing the user experience.

In some embodiments, step 23 can include the following steps 231 and 232:

Step 231: responding to a selection operation for the device configuration item, display a configuration interface corresponding to the device configuration item.

Wherein, the configuration interface corresponding to the device configuration item includes the control operations of the device configuration item and the execution parameters of the control operations.

Optionally, the execution parameters of the control operations can be the execution time and/or execution frequency of the control operations.

For example, the interface 34 shown in FIG. 3D is a configuration interface. The configuration interface can also include other information for setting up smart devices. In the interface 34 shown in FIG. 3D, it also includes whether this device configuration item is executed once, that is, it can set the device configuration item to execute only once or every day, etc.

Step 232: receiving a confirmation operation on the configuration interface for the device configuration item.

In this embodiment, by displaying a detailed configuration interface through the terminal device, the content of the device configuration item can be more detailed, and users can understand the device configuration item in a simple and clear manner.

In some scenes, the content in the configuration interface can be updated by the user, so that the user can modify, delete, and other update operations based on their actual situation, to obtain a configuration that is more in line with their own habits. Specific examples are provided below.

Furthermore, step 23 can include the following steps:

Step 23a: receiving an update operation for the selected target device configuration item, and updating the device configuration item according to the update operation.

Step 23b: responding to a confirmation operation for an updated selected target device configuration item, performing configuration processing on the corresponding device based on the target device configuration item.

Taking the interface 34 shown in FIG. 3D as an example, the control operation 304 and the control operation execution parameters 303 in the configuration interface can be modified. Users can click on the control operation 304 and/or the control operation execution parameters 303 shown in interface 34 to modify them. Thus, when the user clicks “Save,” that is, when a confirmation operation is received, the device is configured with the modified device configuration item.

In this embodiment, the terminal device dynamically learns from user feedback on device configuration items and recent user behavior habits of smart devices, adjusts smart home configuration recommendation items to adapt to changes in user living habits or new needs due to changes in household members, making device configuration items more in line with user needs, and achieving a true smart butler service.

In some scenes, the current methods for creating automated instructions in smart home scenes are mostly based on the user's subjective intentions, and users manually configure them. The device processing method provided in this embodiment is based on automated instruction generation from the control logs of smart devices, changing manual creation to automatic recommendation, and changing configuration based on subjective ideas to configuration based on customer user usage data. A specific example is provided below to illustrate a method for generating device configuration items.

In some embodiments, configuration suggestion items can be generated by the terminal device or by the server. The following provides a detailed explanation using the server-generated configuration suggestion items as an example.

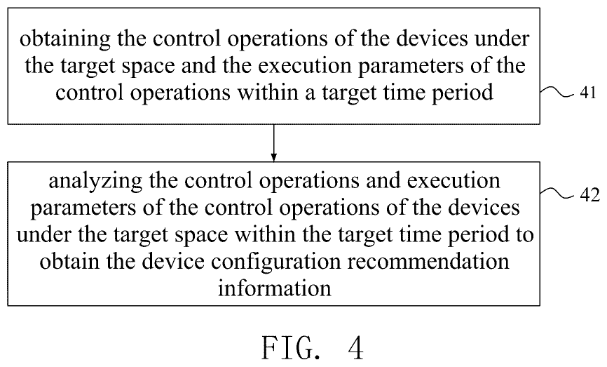

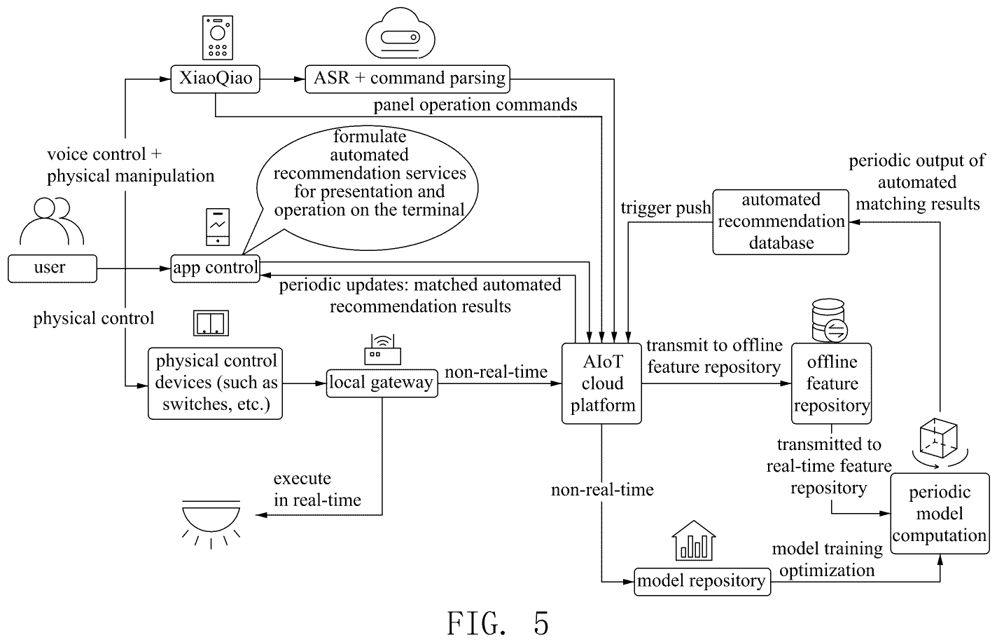

Please refer to FIG. 4, which is a flow diagram of a method for generating device configuration items provided in an embodiment of the present application. The method provided in this embodiment is executed by the terminal device or the server. The following provides a detailed explanation using the processor as the server's processor. The method provided in this embodiment includes the following steps 41 and 42:

Step 41: obtaining the control operations of the devices under the target space and the execution parameters of the control operations within a target time period.

Wherein, the target time period is a pre-set time length, which can be 7 days, 14 days, or other time lengths, and this application does not limit this.

Wherein, the control operations of the devices under the target space and the execution parameters of the control operations within the target time period can be sent to the server by the smart devices, or they can be sent to the server by the terminal devices.

Optionally, the server can obtain the user's usage data of the smart devices within the preset time period at a preset cycle. The server can also obtain the user's usage data of the smart devices in real-time, and obtain the usage data within the preset time period from the real-time obtained user's usage data of the smart devices.

Step 42: analyzing the control operations and execution parameters of the control operations of the devices under the target space within the target time period to obtain the device configuration recommendation information.

The server analyzes and processes the control operations and execution parameters of the control operations of each device under the target space within the target time period, determines whether the control operations and execution parameters of the control operations have stable regularity, and when they have stable regularity, generates device configuration recommendation information based on the control operations and execution parameters of the control operations.

Optionally, step 42 can be implemented in the following manner:

Step 421: For each control operation of the devices under the target space within the target time period, determining whether execution frequency of a control operation within the target time period is greater than or equal to the frequency threshold.

When so, it can be considered that the execution frequency of the target operation is relatively high, and then proceed to step 422. When not, do not proceed to the next processing for this control operation, but return to execute step 421, that is, continue to determine whether the execution frequency of the next control operation within the target time period is greater than or equal to the frequency threshold.

Wherein, the frequency threshold is pre-set and is associated with the target time period and the control operation. That is, each control operation can have a corresponding frequency threshold, and the frequency threshold is set based on the length of the preset time period.

Optionally; the execution frequency can include the number of executions.

For example, when the target time period is 7 days, the frequency threshold can be set to 5 or 6, etc. When the target time period is 15 days, the frequency threshold can be 10 or 12, etc.

Step 422: determining the control operation as a pending analysis control operation.

Step 423: analyzing execution parameters of pending analysis control operations, to obtain a target control operation and a target execution time corresponding to the target control operation.

The server analyzes the execution times of the pending analysis control operations.

For example, based on the execution parameters of the pending analysis control operation, a time series can be obtained, and the stability of the time series can be analyzed to obtain the target control operation and the target execution time corresponding to the target control operation.

Optionally, the execution parameters include execution times, and step 423 can include the following steps:

Step 4231: obtaining expected time of the execution times of the pending analysis control operations.

The server can determine the time mode to which the pending analysis control operation belongs based on the execution time and various time patterns, and obtain the expected execution time of the pending analysis control operation within the time mode.

The time patterns can include but are not limited to: workday mode, weekend mode, and daily mode, etc.

The expected time refers to the predicted time based on the execution time, for example, it can be the average of all execution times.

Step 4232: obtaining the differences between expected time and the execution times of all the pending analysis control operations.

Step 4233: determining whether the number of differences less than the preset time difference accounts for a proportion greater than or equal to a preset proportion threshold of the total number of differences.

When so, proceed to step 4234. When not, return to execute step 421.

Step 4234: determining the pending analysis control operations as the target control operation, and determining the expected time of the execution times of the pending analysis control operations as target execution time corresponding to the target control operation.

Step 424: obtaining the device configuration recommendation information based on the target control operation and the target execution time corresponding to the target control operation.

It can be understood that the device configuration recommendation information in the above embodiment can be obtained through the method provided in this embodiment.

In this embodiment, by generating device configuration recommendation information based on the user's usage data within a preset time period using the server, the device configuration recommendation information is generated based on the user's usage data within the preset time period, which can effectively mine the user's needs for automated command configuration. The device configuration recommendation information is more in line with the user's usage habits. Thus, the terminal device displays an application interface that includes recommendation configuration prompt information, responds to a selection operation on the recommendation configuration prompt information by displaying at least one device configuration recommendation information for the smart device; responds to a confirmation operation on the target device configuration recommendation information in at least one device configuration recommendation information for the smart device, and configures the smart device based on the user's choice, configures the smart device based on the user's voluntary choice, making the smart device configuration more suitable for the user's needs, improving the fit between automated services and the user's actual life. In addition, it saves the user's time for self-configuration, making the smart device configuration more in line with the user's actual usage situation. Furthermore, when the user self-configures, they need to answer quiz questions, but the method in this embodiment has already provided matching suggestion items, and the user can directly determine whether to execute them. Therefore, the method in this embodiment turns quiz questions into judgment questions, significantly reducing the difficulty of configuration automated commands and improving the user experience.

Furthermore, after the terminal device sends a configuration suggestion request message, the server can send device configuration items to the terminal device, or it can also send device configuration items to the terminal device at a preset cycle.

The server obtains high-frequency control operation execution time data within the target time period (which can be the last week or half a month), and analyzes the control operation execution time data from different dimensions in combination with reasonable work and rest patterns, analyzes the regularity and stability of the control operation execution time data. When there is a certain rule in the execution time and the number of executions of the control operation, then the expected value (forecast value) of the execution time is determined, thereby generating automated command configuration suggestion items. After the terminal device makes a request, the configuration suggestion items can be pushed to the terminal device, and the corresponding settings can be made based on the user's operations on the configuration suggestion items.

In some other embodiments, the predictive recommendation function can also be provided from another dimension by collecting historical device data within a preset period, analyzing the stability of the device status values of the historical device data, analyzing whether there is control information that meets the preference adjustment conditions during the corresponding period, calculating the expected (forecast) value of the device status values, using the expected values of each device to match the subsequent device reported data, extracting matching periods; smoothing the data for the matching periods, generating the user's habit preferences and corresponding device control preferences. Below is a detailed explanation with a specific example.

Based on the above embodiment, further, the device configuration recommendation information can also be obtained in the following way:
obtaining user habit data within the target time period;
by analyzing correlation between the user habit data and the control operations of the devices under the target space and the execution parameters of the control operations within the target time period, determining the device configuration recommendation information corresponding to the user habit data.

Wherein, user habit data refers to data that reflects the user's work and rest habits, which can be obtained with the user's permission, for example, user habit data can include user sleep data.

The server analyzes the control preferences of the smart devices corresponding to the user's sleep state, such as the user's control preferences when entering a sleep state and when waking up, and then generates corresponding device configuration items.

For example, the specific method for creating automated instructions is as follows:

First, collecting bedroom device data (mainly control and human sensing types) from 1:00 to 5:00 in the effective period (which can be the last week or half a month); then perform stability analysis of the device status values: whether there is a clear preference for the status values during this period; when there is a pattern, calculate the expected (forecast) value of the device status values;

Using the expected values of each device to compare the device reported data from 21:00 to 12:00 (the next day), extracting matching periods; smoothing the data for the periods (for example, periods less than 10 minutes can be removed, regarded as getting up to use the bathroom; data that deviates significantly from the overall trend can be removed, not included in the daily routine);

Analyzing the wake-up times and sleep times indicated by the sleep period within the validity period for dispersion: wherein data with low dispersion can generate user preferences for wake-up times and sleep times, thus, provide an automated control solution that matches the user's sleep habit preferences.

In some embodiments, in addition to the methods introduced above, the device configuration recommendation information can also be obtained by analyzing the correlation of events or other third-party parameters to determine whether the control operation is the target control operation.

Wherein, the correlation of events is configured to illustrate the relationship between executing different control operations. For example, when the user turns on the light when they come home at 7 o'clock every day, and then turns on the audio-visual equipment after 5 minutes, the light turning on and the audio-visual equipment turning on can be considered related events.

Wherein, other third-party parameters can be data other than the operations performed on the smart devices, for example, they can be the aforementioned user habit data.

Optionally, based on the method and temporal correlations or other third-party parameters described in the aforementioned embodiments, it is possible to determine whether the convergence direction of the timing is reasonable and whether it has reached an appropriate level, thereby obtaining a more suitable expected time.

In some other embodiments, the method for obtaining device configuration recommendation information, in addition to the methods introduced above, can also be based on the device configuration items set by multiple users for push.

For example, when users with similar work and rest schedules own the same device, an analysis can be conducted on the device configuration items that are used relatively frequently: Thereby, the relatively frequent content can be recommended to users with similar work and rest schedules, completing collaborative recommendations.

In some scenes, the control behavior of different devices varies due to differences in execution time and execution parameter sensitivity. Therefore, the initial feature set selection and the subsequent features confirmed through data analysis will be different. The model will periodically learn data from the most recent specified time period and output the latest recommendation content.

Below is an example illustrating the method provided in this embodiment of the application, taking the opening and closing operation of curtain devices as an example. In this example, the control operation is also referred to as an operational event. This example includes the following steps a to d:

Step a: determining the analysis target for the curtain device.

It is necessary to determine the recommendation timing, which corresponds to the execution time of the control operation in the aforementioned embodiment, to locate the timing rule of the automated execution of the event. Determine the recommendation event indicator threshold, which corresponds to the frequency threshold in the aforementioned embodiment, and verify the accuracy and recall rate of the following dimensions to locate the control operations that are recommended for automation.

Furthermore, in the process of data analysis for usage, it can be analyzed separately for natural days and working days. This is to determine whether the user meets the preference convergence requirements based on natural days. When not satisfied, it can be judged again from working days. When selecting the most recent behavioral data for preference calculation, it will also be differentiated according to natural days and working days, that is, whether to skip holiday data. The following judgment conditions can be but are not limited to:

The number of occurrences in the last 15 natural days is >=10 days

The number of occurrences in the last 15 working days is >=10 days

The number of occurrences in the last 10 natural days is >=7 natural days

The number of occurrences in the last 10 working days is >=7 working days

The number of occurrences in the last 5 working days is =5 working days

Meeting any one of the conditions can participate in automated recommendations.

Furthermore, when the conditions are met, the natural day model can be selected.

Step b: determining the thresholds corresponding to different control operations and determining whether the operational events have regularity:

The opening and closing degree operation of the curtain can be divided into fully open (90%˜100%), fully closed (0%˜5%), and half-open (5%˜90%) events, and the whole day is divided into 8 time periods. Record the number of occurrences of the curtain fully closed, fully open, and half-open events in each time period, as well as the average occurrence time points, to locate the past occurrence day number indicator threshold that can be recommended for automation of control operations.

Step c: verifying the above rules.

Select devices with operational actions in all 8 time periods of 8/23 as the verification object to verify the accuracy and recall rate of the predicted actual fully open, fully closed, and half-open operational devices in each time period under different occurrence day number thresholds. The model is static, and the analysis and generation process is the calculation process. Periodically calculate and output the latest automated recommendation results based on the behavioral data of the specified duration in the past. For example, analyze and calculate the data of the past 15 days every Monday to generate recommendation content.

Step d: generating the configuration recommendation items.

Analyze the above data, and the following conclusions are drawn:

The accuracy and recall rate of the working day dimension are relatively high: the recall rate and recommendation quantity under the threshold of 15 working days >=10 days are relatively high compared to other thresholds, so this threshold can be chosen. 63% of the devices with recommended time and actual operation time difference within 30 minutes under the threshold of 15 working days >=10 days are within the acceptable range.

Thereby, the features selected after analysis and verification with different data samples are:

Features related to device control action reasoning: the number of occurrence days of curtain operation events (fully closed, fully open, and half-open) in 15 working days for each time period;

Features related to execution timing reasoning: the average occurrence time points of curtain operation events (fully closed, fully open, and half-open) in 15 working days for each time period;

Features related to device execution opening and closing degree reasoning: the average opening and closing degree of half-open events in 15 working days for each time period.

That is, it can include the target smart device, the target operational event, the execution time of the target operational event, and the target value of the target operational event. Since it is carried out independently for each device, there is no process of selecting the target smart device. Instead, all devices participate in the analysis, and smart devices that meet the preset conditions will generate automated recommendation content, that is, generate configuration recommendation items.

Case: After user A has used the curtain motor for 15 days, the curtain has been opened at around 7 a.m. for 13 days and closed at around 11 p.m. for 12 days. Two device configuration items are generated after 15 days:
device configuration item one: open the curtain to 100% at 7 a.m.;
device configuration item two: close the curtain to 0% at 11 p.m.:

When the user accepts device configuration item one and does not accept device configuration item two. A week later, because the manual operation triggered by the automatic opening at 7 a.m. does not meet the threshold, but the manual operation at 11 p.m. in the last 15 days still meets the recommendation conditions. Therefore, one device configuration item is generated in the second week:
device configuration item three: close the curtain to 0% at 11 p.m.:

In this way, new device configuration items are calculated and generated periodically.

In this application scene, as users' living habits change or the composition of residents changes, the technology can dynamically learn from behavior habits and user feedback, gradually adjust the automation services of smart homes to adapt to new demands, achieving a true smart butler service. It applies artificial intelligence data in home automation but allows for manual intervention and adjustment in the process, avoiding the technical application risks brought by excessive intelligence. The terminal device, based on the user's actual control data, can effectively mine the user's automated command configuration needs, improve the fit between automated services and the user's actual life, and thereby optimize the user experience.

Below is an example introducing a method for generating device configuration items provided in this embodiment of the application, as shown in the system data flow diagram of FIG. 5.

Please refer to FIG. 5, where users can interact with the smart control panel (referred to as “XiaoQiao” in FIG. 5) through voice commands, and can also physically control smart devices through applications installed on terminal devices, or directly control smart devices (e.g., by switches, remote controls, or other physical control devices of the smart device). The aforementioned multiple control methods all provide real-time control over smart devices, with

FIG. 5 illustratively showing smart devices as lamps. The smart control panel, terminal devices, and direct physical control devices of various smart devices are connected to the Artificial Intelligence & Internet of Things (AI+IoT, abbreviated as AIOT) cloud platform through a local gateway, which can be specifically implemented by the aforementioned server. This completes the collection and summarization of smart device data through data reporting from multiple ends. The specifics are as follows: voice interaction panel end: user voice control data on the voice interaction panel will be recognized and parsed into control command information through automatic speech recognition technology (Automatic Speech Recognition, abbreviated as ASR) in the AI cloud, and synchronized to the AIOT cloud platform in real-time: direct panel operation information will also be uploaded to the AIOT cloud platform in real-time. Terminal device application end: manual operation data (non-automated execution) is directly synchronized to the AIOT cloud platform in real-time. Smart device end: direct physical control data of smart devices in the space are stored in the local gateway in real-time, and status data will be regularly or triggered to be reported to the gateway, and the local gateway will periodically report to the AIOT cloud platform.

The AIOT cloud platform can include: an automation recommendation database, an offline feature repository; and a model repository:

Among them, the model repository can include one or more reasoning models. By intervening in the historical usage data of smart devices by users or by training models, reasoning models of different types of automated configurations are formed. The model repository can be continuously iterated and optimized in combination with the verification of new user usage data of smart devices. The model repository can train models, and the preliminary work of model training includes feature selection. Feature selection, also known as feature subset selection or attribute selection, refers to the process of selecting N features from the existing M features to optimize specific indicators of the system, which is the process of selecting some of the most effective features from the original features to reduce the dimension of the dataset. It is an important means to improve the performance of learning algorithms and a key data preprocessing step in pattern recognition.

The offline feature repository is configured to generate features, which correspond to the device configuration items in the aforementioned embodiments. The AIOT cloud platform can receive usage data reported by multiple users' smart devices through data collection and reporting paths, and the AIOT cloud platform cleans and processes the reported user usage data to generate non-real-time feature data, stored in the feature repository:

Used for reasoning calculations of automated recommendation content based on historical device operation data. Non-real-time features can be generated based on usage data from the most recent preset period within the update cycle (e.g., 15 working days or natural days). For example, when the recommendation model is set to update once a week, then the data from the most recent 15 days will be used for feature generation and model calculation, where weekly and 15 days are configurable parameters that can be adjusted based on actual test results.

The automation recommendation database is configured to generate and store device configuration items. The automation recommendation database generates automated recommendation-related device configuration items based on historical device operation data and stores them in the automation recommendation database. The content of historically stored device configuration items will be refreshed with new device configuration items, and when the terminal device issues a request, the AIOT cloud platform will push the verified device configuration items to the terminal device, enabling the terminal device to provide recommendation prompts and displays.

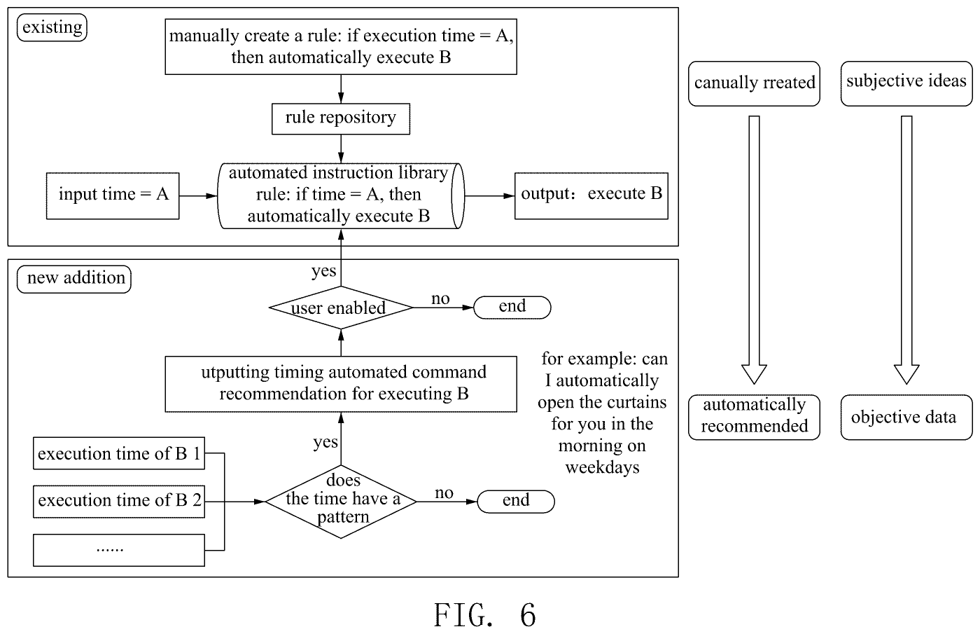

Below is an illustration of the effect of the method provided in this embodiment of the application, as shown in the difference diagram between the device processing method provided in this embodiment and existing technology, as shown in FIG. 6.

Please refer to FIG. 6, as shown in the figure above, the process displayed in the upper left box labeled “Existing” is the current method of creating device configuration recommendation information in smart home scenes, which is based on the user's subjective intent to manually create automated commands, for example, when the execution time is A, then set to automatically execute control operation B. The manually set rule is stored in the database, and control operation B is automatically executed when time A is met.

The process displayed in the upper left box labeled “New” is the new process steps added by the device processing method proposed in this application on the basis of the existing method. The specific method of this application can be as follows:

1. Firstly, obtaining the execution time data of high-frequency control behaviors (B) within the target time period (which can be the last week or half a month). FIG. 6 illustratively shows the execution time 1 of B, the execution time 2 of B, etc.

2. Determining whether the execution time data of B has a pattern.

Features can be developed from different dimensions in conjunction with reasonable work and rest patterns to analyze the regularity and stability of the execution time data. When not, the determination ends: when so, proceed to step 3 below.

3. Calculating and outputting the timing automated command recommendation for executing B. That is, calculate the expected value (forecast value) of the execution time of B. Wherein, this timing automated command recommendation is the device configuration item in the aforementioned embodiments.

4. Generating the device configuration items and pushing them on terminal devices.

5. Determining whether the device configuration item is enabled by the user.
if so, it can be applied to the target device; if not, it will not be applied to the target device.

Users can directly confirm or modify and confirm, then directly add the device configuration item to the user's automated command library.

As can be seen from FIG. 6, the existing manual creation method requires users to set up on their own, increasing the difficulty of user setup, and based on the user's subjective ideas for setup, sometimes it cannot truly and comprehensively reflect user habits. The device processing method provided in this application changes the existing user manual creation method to an automatic recommendation method, eliminating the need for users to configure subjectively, reducing the configuration difficulty, and the existing method is based on user subjective ideas for configuration, while this application is based on customer data for objective configuration, improving the accuracy of the configuration items and better meeting user habits.

In some embodiments, a scene is essentially a virtual scene created on a computing device, which corresponds to a real spatial environment, such as a smart home environment. For example, a real smart home environment can be a room equipped with several devices. Thus, the creation of this scene on the computing device, that is, the configuration of the scene by the computing device, specifically refers to mapping the several devices deployed in the smart home environment through device identifiers in the scene, and configuration corresponding actions for these devices through action identifiers. It can also be understood that in a created scene (i.e., a configured scene), it includes at least the device identifiers of several devices deployed in the smart home environment and the action identifiers for the corresponding actions configured for these devices. Wherein, the device identifier is used to represent the device that has been mapped in the target scene in the smart home environment, and the action identifier is used to represent the action configured for the device that has been mapped with the device identifier in the target scene. Based on this, by executing the scene, each device in the smart home environment can perform the corresponding actions configured in the scene.

The operational attributes of a device, which are used to indicate at least one of the actions performed by the device, the state of the device after the action is executed, and the time when the device performs the action.

The scene configuration attributes of a device, which are used to indicate the actions configured for the device in the scene.

TTS, whose full English name is Text To Speech, and its Chinese meaning is from text to speech, as part of the human-computer dialogue, aims to intelligently transform text into a speech stream, enabling machines to speak.

The beneficial effects of the technical solution provided by this disclosure are:

In the aforementioned technical solution, historical device operation data that records at least the operational attributes of the device are obtained, and based on the operational attributes of the device recorded in the historical device operation data, the device configuration requirements for the target scene are determined, and a scene configuration plan is generated for the target scene according to the device configuration requirements, enabling at least one device to perform corresponding actions configured in the target scene according to the scene configuration plan. In other words, by proactively understanding user needs through historical device operation data, when it is determined that user needs are dynamically adjusted, a scene configuration plan can be automatically generated for the target scene, avoiding manual operations by users to adjust the configured old scenes or create new scenes, thus effectively solving the problem of low efficiency in scene configuration in related technologies.

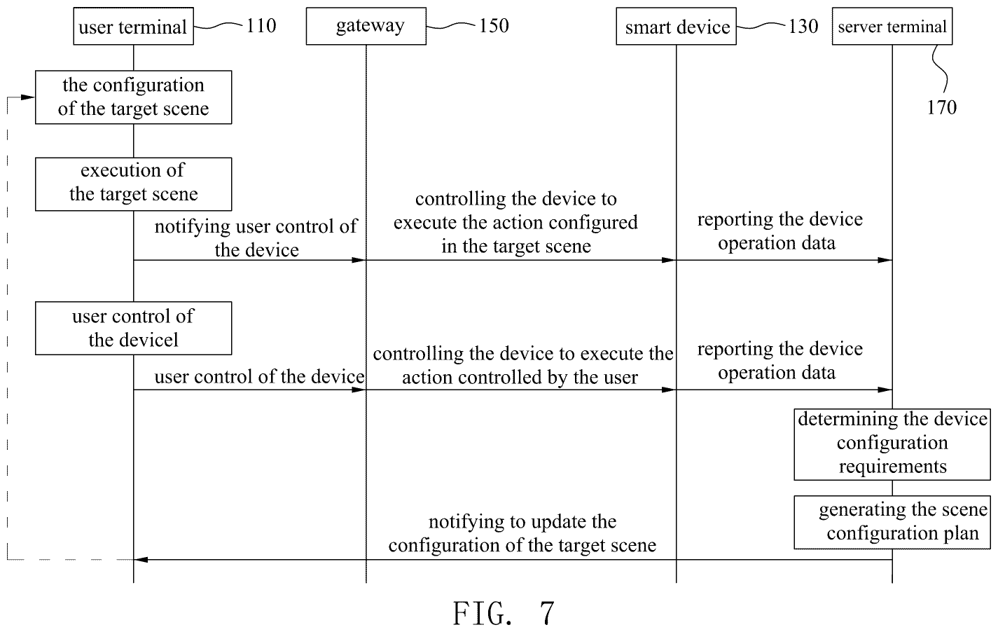

As shown in FIG. 7, users can configure target scenes through user terminal 110 according to their actual needs, so that the next time the target scene is executed, several devices that have undergone device identifier mapping in that target scene can perform corresponding actions configured in that target scene.

As user needs dynamically adjust, for example, when a user controls at least one of the several devices, such as smart device 130, for example, after entering winter, the brightness of the smart light executing in the home scene is adjusted from 10% to 30%, then for the smart device 130, it will actively record the user's control of the smart device 130, add it to the historical device operation data, and send this historical device operation data to the server terminal 170.

For the server terminal 170, after the smart device 130 sends the historical device operation data, it can obtain this historical device operation data and provide a device control server for the user based on this historical device operation data, which specifically means determining the device configuration requirements for the target scene based on this historical device operation data, to confirm whether the user's needs have dynamically adjusted, if so, automatically generating a scene configuration plan for the target scene according to the device configuration requirements, enabling several smart devices 130 that have undergone device identifier mapping in that target scene to perform corresponding actions configured in the target scene according to the scene configuration plan, achieving automatic updates of target scene configurations as user needs dynamically adjust, which not only improves the efficiency of scene configuration but also avoids the complexity of user manual operations, greatly reducing the user's usage cost and enhancing the user's usage experience.

In one implementation, the device configuration recommendation information includes a scene configuration plan for the target scene;

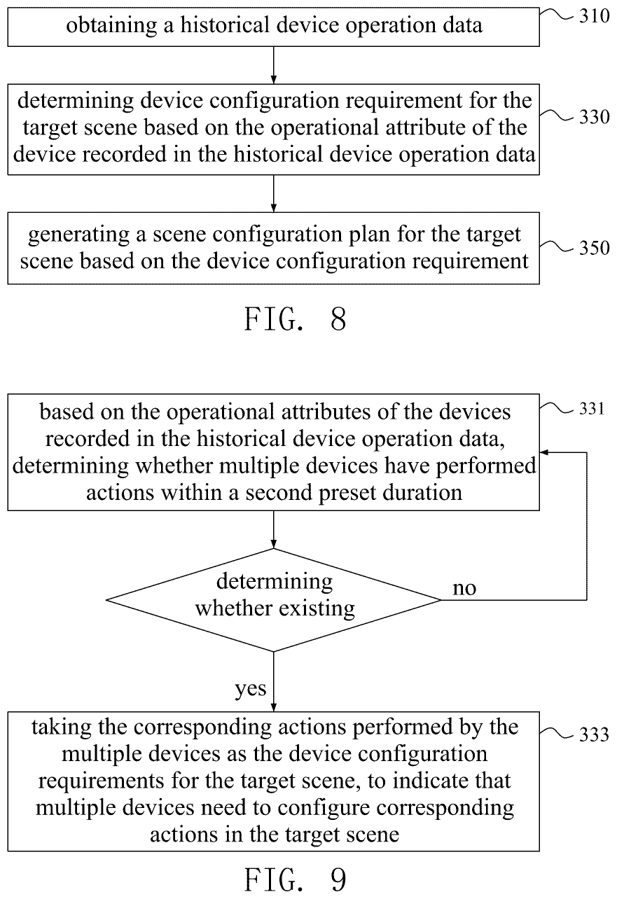

If device configuration recommendation information for devices under the target space is obtained, before pushing and displaying the said device configuration recommendation information, as shown in FIG. 8, the method can include the following steps:

Step 310, obtaining a historical device operation data.

Wherein, the historical device operation data records at least the operational attribute of the device.

It should be explained first that the essence of historical device operation data is to record every action executed by the device, not only recording every action executed by the device, but also the state of the device after the action is executed. Of course, in other embodiments, the historical device operation data also records the time when the device performs the action. In one possible implementation, the historical device operation data is stored in the device in the form of an operation log.

Based on this, the operational attribute of the device can be used to indicate one or more of the actions performed by the device, the state of the device after the action is executed, and the time when the device performs the action. In one embodiment, the operational attribute include control operations of the device under the target space within a target time period and the execution parameters of the control operations. Wherein, the execution parameters can include execution time and/or execution frequency.

In one possible implementation, the action executed by the device is for the target scene, that is, the action executed by the device is the action configured for the device in the target scene.

For the device, after each action is executed, the device will correspondingly store the action executed this time, the time when the action is executed this time, and the state of the device after the action is executed this time, as the operational attributes of the device and add them to the historical device operation data. In one possible implementation, the device forwards the historical device operation data to the server terminal through a gateway, which specifically means that the device reports the historical device operation data to the gateway based on a local area network, and the gateway forwards the historical device operation data to the server terminal. In another possible implementation, the computing device reports the historical device operation data to the server terminal based on a wide area network.

Then, for the computing device, regarding the acquisition of historical device operation data, the historical device operation data can come from the historical device operation data reported by the device in real-time, which facilitates real-time processing of the historical device operation data and improves the timeliness of processing. It can also come from the historical device operation data stored within a historical time period, which facilitates batch processing of the historical device operation data and improves the efficiency of processing.

Step 330, determining device configuration requirement for the target scene based on the operational attribute of the device recorded in the historical device operation data.

As mentioned earlier, historical device operation data is a record of every action executed by the device, and it should be understood that historical device operation data will also record any subsequent actions executed by the device after the scene is executed. For example, when it's hot, when a user comes home, the execution of the home scene actually means automatically turning on the lights, increasing the brightness of the lights, closing the windows, closing the curtains, and turning on the air conditioner; as the weather gradually cools down, at least there is no need to turn on the air conditioner, that is to say, at this time, when a user comes home, after the home scene is executed, the user still needs to turn off the air conditioner. In the aforementioned process, for historical device operation data, it not only records the air conditioner executing the open action configured in the home scene but also records the air conditioner executing the close action after the home scene is executed.

It can be seen that by the operational attributes of the device recorded in the historical device operation data, it is possible to determine whether the user's needs have dynamically adjusted. Continuing with the aforementioned example, after it gets cold, the user turns off the air conditioner after the home scene is executed, and the computing device can determine that the user's needs have dynamically adjusted based on the open action of the air conditioner executed in the home scene recorded in the historical device operation data, and the close action of the air conditioner executed after the home scene is executed, that is to say, for the home scene, the user's needs have been adjusted from turning on the air conditioner to turning off the air conditioner.

In this embodiment, the device configuration requirement is used to indicate that at least one device needs to configure a corresponding action in the target scene, which also reflects that the user's needs have dynamically adjusted. Still, using the aforementioned example, the device configuration requirement are used to indicate that the air conditioner needs to configure the close action in the home scene, where the target scene is the home scene, the device is the air conditioner, and the corresponding action is the close action.

In one possible implementation, as shown in FIG. 9, step 330 may include the following steps: Step 331, based on the operational attributes of the devices recorded in the historical device operation data, determining whether multiple devices have performed actions within a second preset duration, the second preset duration refers to the time period during which multiple devices continuously perform actions: for example, the second preset duration is 10 minutes, indicating that multiple devices have continuously performed actions within those 10 minutes: Step 333, if yes, then taking the corresponding actions performed by the multiple devices as the device configuration requirements for the target scene, to indicate that multiple devices need to configure corresponding actions in the target scene.

In this manner, although the target scene has not been executed, the user has continuously controlled multiple devices to perform corresponding actions within a period of time (for example, 10 minutes). That is to say; if the user expects to achieve one-click control over these multiple devices next time, it may take a considerable amount of time to configure the target scene, which could be the reconfiguration of the target scene or the creation of the target scene. At this point, it is regarded as a dynamic adjustment of the user's needs. The actions performed by the devices can be the actions configured for the devices in the target scene, and can also refer to new actions that the devices have not been configured for in the target scene, this is not limited here.

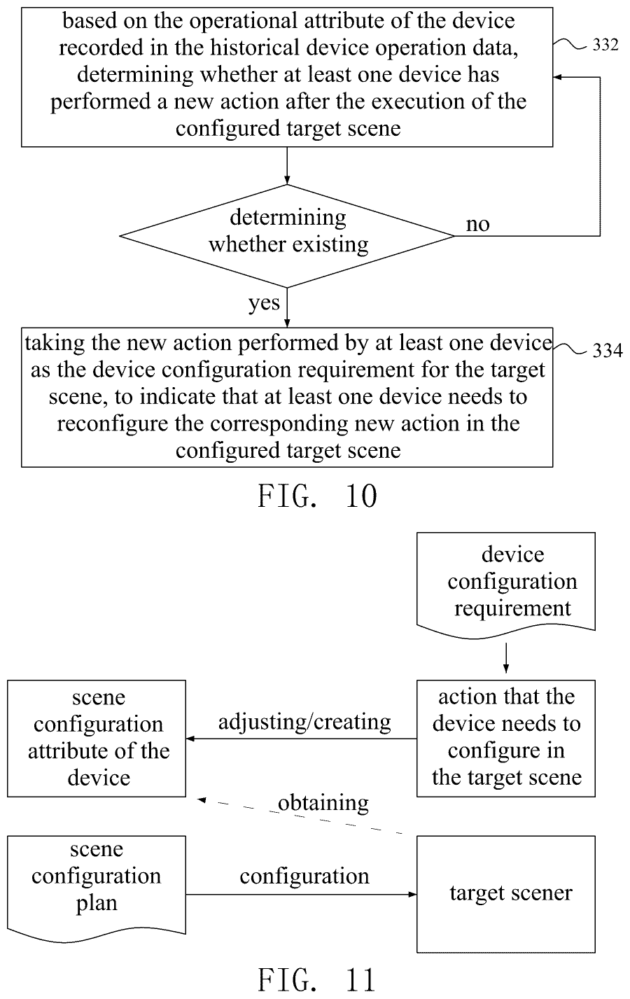

In one possible implementation, as shown in FIG. 10, step 330 may include the following steps: Step 332, based on the operational attribute of the device recorded in the historical device operation data, determining whether at least one device has performed a new action after the execution of the configured target scene, the new action is different from the action configured for the device in the configured target scene; Step 334, if yes, then taking the new action performed by at least one device as the device configuration requirement for the target scene, to indicate that at least one device needs to reconfigure the corresponding new action in the configured target scene.

In this manner, for the target scene that has been executed, the user still controls one or more devices, that is, controls the one or more devices to perform new actions that are not configured in the target scene. This means that the executed target scene may not meet the user's needs, and it is also regarded as a dynamic adjustment of the user's needs.

Wherein, for the target scene that has been executed, regarding whether at least one device has performed a new action not configured in the target scene, there are the following two possible confirmation methods:

In one possible implementation, the computing device determines the frequency of the device performing a new action within a first preset duration based on the operational attributes of the device recorded in the historical device operation data, the first preset duration refers to the time period during which the configured target scene is executed multiple times consecutively; for example, the first preset duration is 3 days, indicating that the configured target scene is executed multiple times consecutively within those 3 days; if the frequency exceeds the preset frequency threshold, it is determined that a device has performed a new action. In this manner, if the target scene is executed multiple times consecutively within the first preset duration (for example, 3 days), and the same device performs a new action not configured in the target scene multiple times, it is regarded as a dynamic adjustment of the user's needs.

In one possible implementation, the computing device determines the number of devices performing a new action after the execution of the configured target scene based on the operational attributes of the device recorded in the historical device operation data: if the number exceeds the preset quantity threshold, it is determined that multiple devices have performed new actions. In this manner, if multiple devices perform new actions not configured in the target scene after the execution of the target scene, it can also be regarded as a dynamic adjustment of the user's needs.

It should be noted that the first preset duration and the second preset duration can both be flexibly adjusted according to the actual needs of the application scene, and are not limited here. For example, the first preset duration is 3 days. Similarly, the quantity threshold and the frequency threshold can also be flexibly adjusted according to the actual needs of the application scene, and are not specifically defined here. For example, the quantity threshold is 3.

From the above, it can be seen that multiple devices performing actions under control within the same period of time, or the same device performing new actions under control multiple times after the execution of the target scene, will both be automatically categorized as belonging to the scope of dynamic adjustment of user needs, and can be used as the basis for configuration the target scene to meet the user's actual needs.

Step 350, generating a scene configuration plan for the target scene based on the device configuration requirement.

After determining the device configuration requirement for the target scene, a scene configuration plan can be generated for the target scene. The target scene can refer to an already created old scene, in which case, the scene configuration plan refers to adjusting the scene configuration attribute of the devices in the target scene that have already been created: the target scene can also refer to a new scene that has not been created, in which case, the scene configuration plan refers to creating the scene configuration attributes of the devices in the target scene. In one possible implementation, the scene configuration plan includes at least the scene configuration attribute of the device. In another possible implementation, the scene configuration plan also includes the device identifier of the device. Wherein, the scene configuration attribute of the device is used to indicate at least one of the actions configured for the device in the target scene, and the state of the device after executing the action configured in the target scene.

In one possible implementation, step 350 may include the following steps: creating the scene configuration attributes of the device in the target scene based on the actions that the device needs to configure in the target scene as indicated by the device configuration requirements: generating a scene configuration plan based on the scene configuration attributes that have been created for each device in the target scene.

In one possible implementation, step 350 may include the following steps: obtaining the scene configuration attributes that have been created for the device in the target scene; adjusting the scene configuration attributes of the device in the target scene based on the actions that the device needs to configure in the target scene as indicated by the device configuration requirements: generating a scene configuration plan based on the adjusted scene configuration attributes of each device in the target scene.

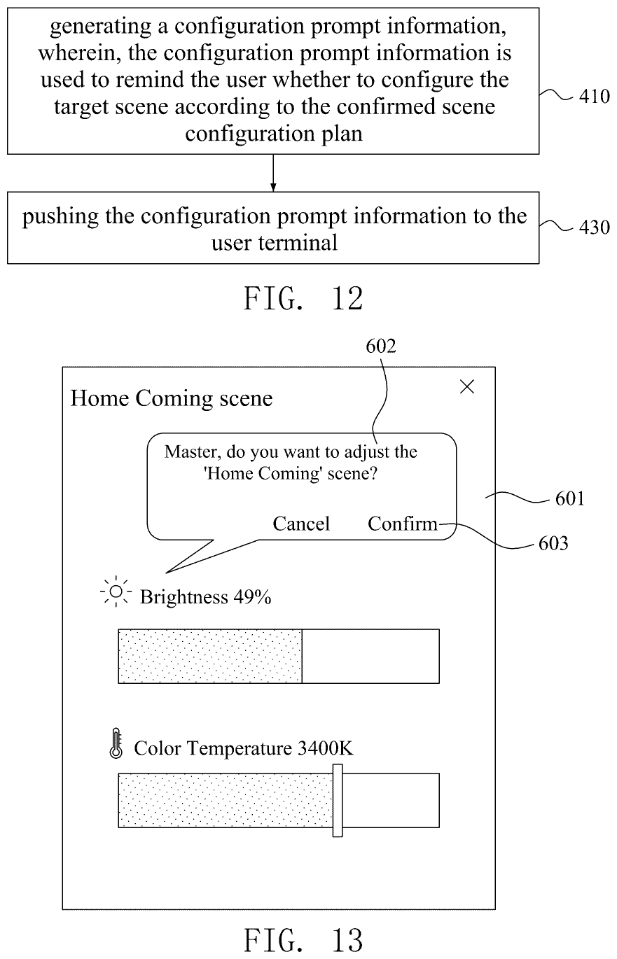

That is to say, as shown in FIG. 11, the computing device transforms the action that the device needs to configure in the target scene as indicated by the device configuration requirements into the scene configuration attributes of the device, and adds them to the scene configuration plan to facilitate the configuration of the target scene. For example, the device configuration requirement indicates that the smart light needs to configure an action to adjust the brightness to 30% in the home scene. If the scene configuration attribute of the smart light in the already created target scene indicates that the action configured for the smart light in the home scene is to adjust the brightness to 10%, then through comparison, adjusting the brightness to 30% will be taken as the new scene configuration attribute for the smart light, added to the scene configuration plan, so that the next time the target scene is executed, the smart light will adjust the brightness to 30%. Of course, in other embodiments, the scene configuration attribute is also used to indicate the state of the device after executing the action configured in the target scene, and this is not specifically limited here.

Still using the aforementioned example for illustration, the scene configuration attribute of the smart light indicates that the brightness of the smart light after performing the action in the home scene is 10%. Then, by comparing it with the brightness of 30% indicated by the device configuration requirement, the brightness of 30% will be taken as the new scene configuration attribute for the smart light, added to the scene configuration plan. Thus, the next time the target scene is executed, the smart light will adjust the brightness to 30%.

After generating the scene configuration plan, the computing device will configure the target scene according to the scene configuration plan. In one possible implementation, the scene configuration plan is sent to the user terminal, so that the user terminal can configure corresponding actions for at least one device in the target scene based on the scene configuration plan. Thereafter, as the user executes the target scene with one click through the user terminal, at least one device that has undergone device identifier mapping in the target scene can be controlled to perform corresponding actions configured according to the scene configuration plan in the target scene.

In the process mentioned above, by recording the operational attributes of the device in the historical device operation data, it is possible to proactively understand the user's needs. When it is determined that the user's needs have dynamically adjusted, a scene configuration plan that meets the user's needs after the dynamic adjustment can be automatically generated for the target scene. This avoids the user's manual operation to adjust the configured old scene or create a new scene. This not only improves the efficiency of scene configuration but also avoids the complexity of user manual operation, greatly reducing the user's usage cost and enhancing the user's usage experience, thus effectively solving the problem of low scene configuration efficiency in related technologies.

Please refer to FIG. 12, in this embodiment, a possible implementation is provided after step 350, and the method may further include the following steps:

Step 410, generating a configuration prompt information.

Wherein, the configuration prompt information is used to remind the user whether to configure the target scene according to the confirmed scene configuration plan.

Step 430, pushing the configuration prompt information to the user terminal.

To avoid the target scene from being inapplicable in the smart home environment, or can be considered to avoid the user's dissatisfaction with the target scene. In this embodiment, before configuration the target scene according to the scene configuration plan, a configuration prompt information is pushed to the user terminal.

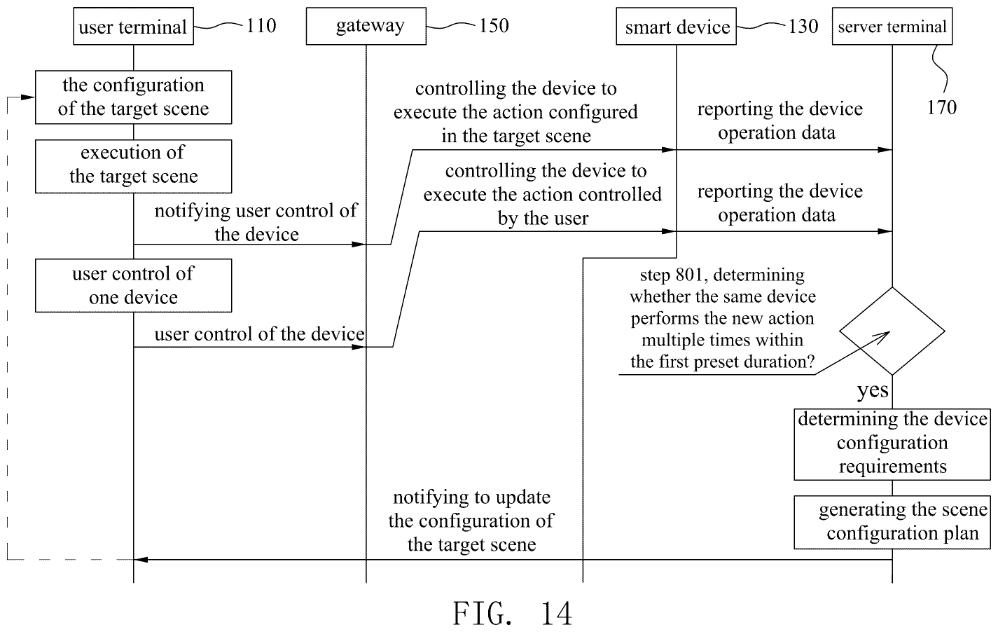

In one possible implementation, display the configuration prompt information. Taking the computing device as a smart control panel as an example, as shown in FIG. 13, the configuration prompt information 602: “Master, do you want to adjust the ‘Home Coming’ scene?” is displayed on the display interface 601 of the smart control panel. If the user clicks the “Confirm” control 603, it means the user wants to adjust the scene of returning home. At this time, the smart control panel automatically reconfigures the target scene of returning home according to the scene configuration plan. In this way, a quick entry for the user to adjust the target scene is provided. The user can achieve the reconfiguration of the target scene through the trigger operation of this entry:

In one possible implementation, the computing device sends the configuration prompt information to the smart device, controlling the smart device to give a voice prompt to the user according to the configuration prompt information. For the smart device, through the TTS technology provided by the voice output module configured on the smart device, the text form of the configuration prompt information can be transformed into voice feedback to the user, for example, “Master, do you want to create a scene?”. In this way, an efficient voice interaction mode is realized. The user does not need any manual operation, and only needs to answer “Yes” to achieve the creation of the target scene.

Under the effect of the above embodiment, a user interaction mode for the configuration of the target scene is realized, which can be a trigger mode of interaction, and can also be a voice mode of interaction. The user can simply and efficiently achieve the configuration of the target scene, which can be the reconfiguration of the target scene, and can also be the creation of the target scene. The user does not need to care about which device should be configured with which action in the target scene, thus greatly reducing the complexity of user manual operation, and thereby greatly reducing the user's usage cost, and ultimately benefiting the improvement of the user's usage experience.

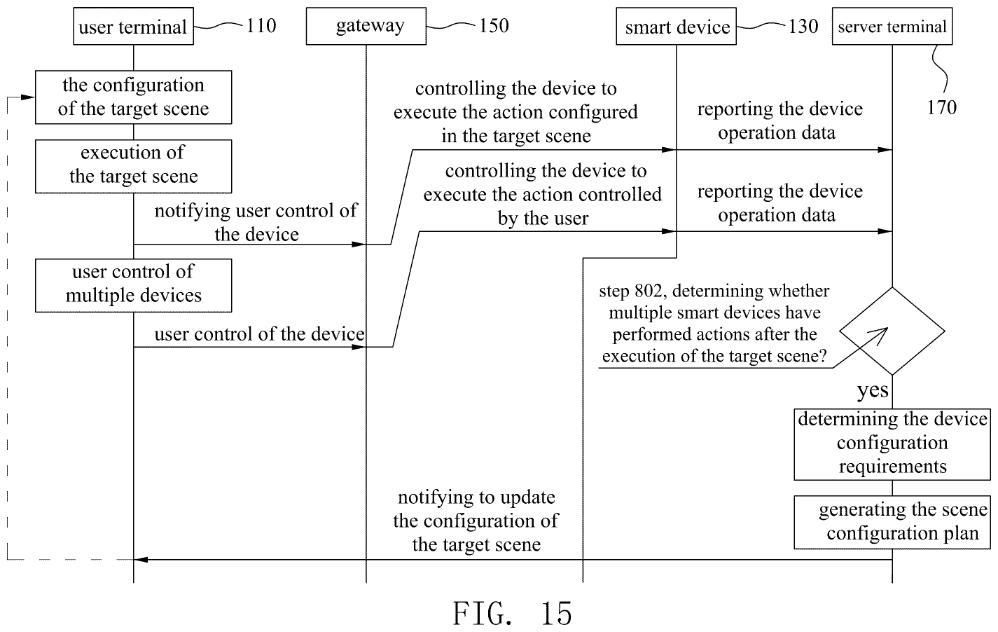

FIGS. 14 to 16 are specific implementation schematic diagrams of a device processing method in an application scene. This application scene applies to the devices shown in the implementation environment of FIG. 1.

In this application scene, the user terminal 110 is a smart control panel, enabling the user to directly control the smart device 130 to perform corresponding actions through the smart control panel, or indirectly control the smart device 130 to perform actions configured in the created target scene through the smart control panel: the smart device 130 is deployed on the gateway 150, controlled to perform corresponding actions by accessing the gateway 150 through a local area network, and can interact with the server terminal 170 through a wide area network, or the data is forwarded to the server terminal 170 by the gateway 150 through a local area network.

Now, combined with FIGS. 14 to 16, the following explanations are given for the three target scene configuration plans involved in the device control process:

The first scene configuration plan:

As shown in FIG. 14, in the first scene configuration plan, the user configures the target scene through the user terminal 110 according to their actual needs, and through the execution of the target scene, causes several smart devices 130 that have undergone device identifier mapping in the target scene to perform corresponding actions configured in the target scene, thereby causing the smart devices 130 to report corresponding historical device operation data to the server terminal 170.

As the user controls one of the several smart devices 130, for that smart device 130, while performing the corresponding action under control, it will also actively record the control of the user on that smart device 130 as the operational attribute of that smart device 130, add it to the historical device operation data of that smart device 130, and report the historical device operation data to the server terminal 170.

For the server terminal 170, by executing step 801, if it is determined that within the first preset duration (3 days) where the target scene is executed multiple times consecutively, the smart device 130 also performs new actions multiple times, that is, different from the actions configured for the smart device 130 in the target scene, it is considered that the executed target scene may not meet the user's needs, and it is further considered that the user's needs have been adjusted, then determine the device configuration requirement, and generate a scene configuration plan according to the device configuration requirements, to notify the user terminal 110 to update the configuration of the target scene.

At this time, for the user terminal 110, after receiving the scene configuration plan, it can adjust the configuration of the target scene according to the scene configuration plan, to meet the user's dynamically adjusted needs.

The second scene configuration plan:

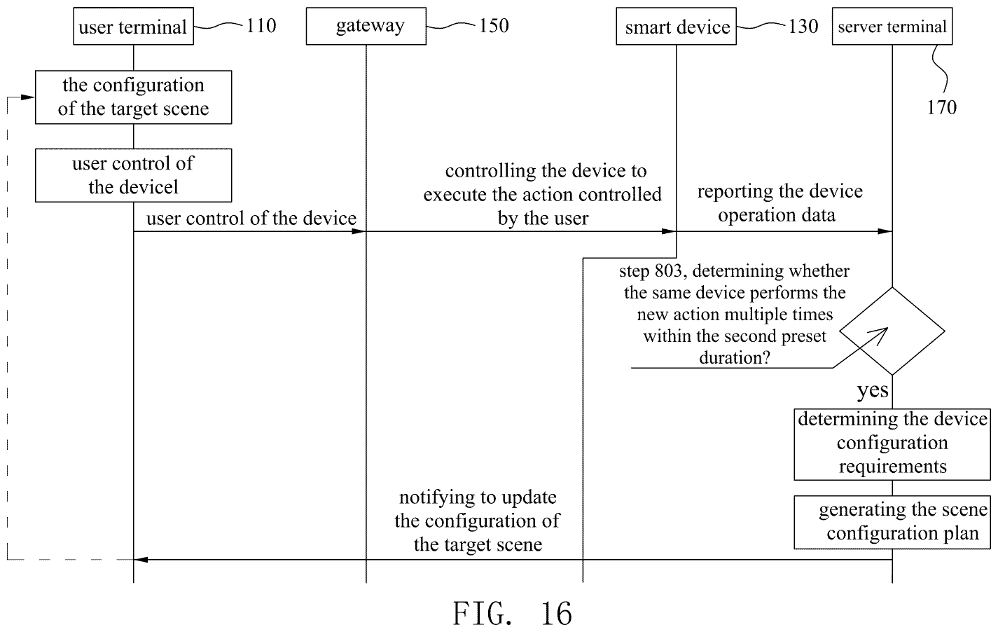

As shown in FIG. 15, in the second scene configuration plan, different from the first scene configuration plan, after the execution of the target scene, the user will control multiple smart devices 130 among several smart devices 130.

At this time, for the server terminal 170, by executing step 802, if it is determined that after the execution of the target scene, multiple smart devices 130 have performed corresponding actions under control, it is also considered that the executed target scene may not meet the user's needs, and it is further considered that the user's needs have been adjusted, then determine the device configuration requirements, and generate a scene configuration plan based on the device configuration requirements, to notify the user terminal 110 to update the configuration of the target scene.

Correspondingly; in the user terminal 110, the configuration of the target scene will be adjusted according to the scene configuration plan sent by the server terminal 170, to meet the user's dynamically adjusted needs.

The above two scene configuration plans are both executed after the target scene, based on the user's continued control over one or more smart devices 130 after the execution of the target scene, thereby actively understanding the user's dynamic needs and achieving satisfaction of the user's dynamic needs.

The third scene configuration plan:

As shown in FIG. 16, in the third scene configuration plan, different from the first two scene configuration plans, the target scene has not been executed. The target scene may have been created or may not have been created yet, and the user directly controls multiple smart devices 130, specifically referring to the user continuously controlling the multiple smart devices 130 to perform actions within the second preset duration (10 minutes).

At this time, for the server terminal 170, by executing step 803, if it is determined that multiple smart devices 130 have performed corresponding actions under control within 10 minutes, it is considered that if the user expects to achieve one-click control over these multiple smart devices 130 next time, it may take a considerable amount of time to configure the target scene, which may be the reconfiguration of the created target scene or the configuration of the not yet created target scene, and it is further considered that the user's needs have been adjusted, then determine the device configuration requirements, and generate a scene configuration plan based on the device configuration requirements, to notify the user terminal 110 to update the configuration of the target scene.

Correspondingly, in the user terminal 110, the target scene will be created according to the scene configuration plan sent by the server terminal 170, that is, configure corresponding actions for the multiple smart devices 130 in the target scene, to meet the user's needs after dynamic adjustment.

It can be seen that, in the third scene configuration plan, although the target scene has not been executed, based on the user's continuous control over multiple devices to perform corresponding actions within a period of time (10 minutes), the user's dynamic needs can also be actively understood and satisfied.

In this application scene, achieving automatic updates of target scene configurations following the dynamic adjustments of user needs not only improves the efficiency of scene configuration but also avoids the complexity of user manual operations, greatly reducing the user's usage cost and enhancing the user's usage experience.

In one implementation, the device configuration recommendation information includes device control commands corresponding to the target scene.

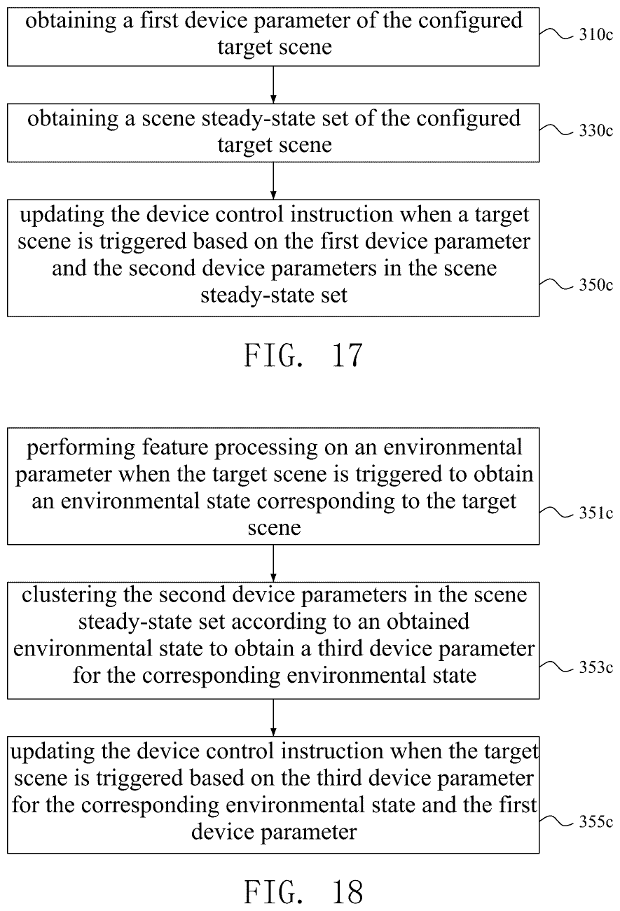

As shown in FIG. 17, after the configuration processing of the corresponding device based on the target device configuration item to apply the target device configuration item, the method can further include the following steps:

Step 310C, obtaining a first device parameter of the configured target scene.

It should be noted that the target scene is a device control method for multiple smart devices to be configured in linkage, which may include one or more device control commands. When the target scene is triggered, each device control command will be sent to the corresponding smart device, causing the smart device to execute the initial action configured in the target scene. For example, a configured target scene, such as a “home coming” scene, might be “turn on the living room light, entrance light, and living room air conditioner when someone is detected in the entrance.” When the home coming scene is triggered, the living room light and entrance light will be turned on, and at the same time, the living room air conditioner will also be activated.

Secondly, the first device parameter is generated by the smart device executing the initial actions configured in the target scene and can be understood as indicating the device state of the smart device after executing the initial actions. For instance, in the “home coming” scene, the initial action configured for the living room air conditioner is “turn on the cooling mode, cool to 23° C.”. Correspondingly, the device control command is “turn on the cooling mode, cool to 23° C.”. When the home coming scene is triggered, this device control command is sent to the living room air conditioner, causing it to perform the action “turn on the cooling mode, cool to 23° C.”. Thereby, the first device parameter can indicate that the device state of the living room air conditioner after executing the initial action is “cooling mode, temperature 23° C.”. Thus, a target scene can include multiple device control commands, and when the target scene is triggered, each device control command is sent to the corresponding smart device to execute the initial action. Consequently, multiple smart devices executing initial actions will generate multiple corresponding first device parameters. Using the aforementioned home coming scene as an example, when the home coming scene is triggered, it can generate three first device parameters, indicating “living room light on”, “entrance light on”, and “living room air conditioner on”.

In one implementation, the first device parameter is generated based on the initial actions configured by the device configuration recommendation information generated from historical device operation data under the target scene. The historical device operation data can include control operations of the devices under the target space and execution parameters of the control operations within a target time period. Specifically, the first device parameter can be generated after the smart device executes actions corresponding to the control operations and execution parameters of the control operations.

Of course, the number of first device parameters when different target scenes are triggered can vary, determined by the number of device control commands configured in the target scene, without specific limitation here.

Step 330C, obtaining the scene steady-state set of the target scene.

Wherein, the scene steady-state set includes the second device parameters generated during multiple scene observation periods, and the second device parameters are generated by the smart device executing additional actions during a single scene observation period. It is noted that additional actions refer to actions executed by the smart devices in the target scene during the scene observation period, which are different from the initial actions configured for the smart devices in the target scene.

When the target scene is triggered, the initial actions executed by the smart devices configured under the target scene may not meet the user's expectations. For example, if the current ambient temperature drops and the home coming scene is configured with “turn on the living room air conditioner cooling mode,” meaning the initial action configured for the living room air conditioner in the home coming scene is “turn on the cooling mode,” it does not conform to the actual situation. Based on this, the user manually turns off the living room air conditioner shortly after the home coming scene is triggered. The user manually turning off the living room air conditioner is considered an additional action executed by the living room air conditioner during a single scene observation period, and the resulting second device parameter can be “turn off the living room air conditioner.” It is understood that not every time the target scene is triggered will a second device parameter be generated: if the smart device does not execute any additional actions during the scene observation period, then there will be no corresponding second device parameter for this triggering of the target scene.

Regarding the scene observation period, it refers to the time period set after the target scene is triggered to observe whether the smart devices under the target scene execute additional actions. For example, the scene observation period can be within 1 minute after the target scene is triggered. The setting of the scene observation period can be used to determine whether the user has made additional controls on the smart devices after the target scene is triggered, thereby determining whether the user is satisfied with the device linkage control based on the target scene. For instance, if the user makes additional manual controls on the smart devices during multiple scene observation periods, it indicates that the device control carried out based on the target scene does not meet the user's expectations.

It is worth mentioning that the length of the scene observation period can affect the accuracy of instruction optimization. Since the second device parameters are generated by smart devices executing additional actions during a scene observation period, if the scene observation period is too short, the smart device may not have executed the additional actions before the scene observation period ends, thus failing to understand the user's attitude towards the target scene configuration, which leads to unsuccessful and accurate instruction optimization. Conversely, if the scene observation period is too long, it may result in many untrustworthy pieces of information in the scene steady-state set of the second device parameters. For example, after the target scene is triggered, if the time changes from evening to morning and the user turns off the light device in the target scene due to the influence of sunlight, and the user's action of turning off the light device is a normal device control, if the scene observation period is indefinitely extended, considering the light device turned off as an additional action executed by the light device during a single scene observation period and generating the second device parameter, then the instruction optimization based on this second device parameter will misinterpret the user's intention, leading to errors in the instruction optimization results.

From the above, it can be seen that both of the aforementioned situations may lead to inaccurate instruction optimization results. Therefore, in one possible implementation, adjusting the scene observation period can include the following steps: determining the feedback quantity for the scene observation period within a set time period; adjusting the scene observation period based on the feedback quantity. The feedback quantity indicates the number of times additional actions executed by the smart device during the scene observation period. It should be understood that when the feedback quantity indicates that the number of times the smart device executes additional actions during the scene observation period is exceptionally low; the scene observation period can be appropriately extended after determining that the abnormality is caused by the scene observation period being too short; when the feedback quantity indicates that the number of times the smart device executes additional actions during the scene observation period is exceptionally frequent, the scene observation period can be appropriately shortened after determining that the abnormality is caused by the scene observation period being too long, thus better understanding the user's true intentions and accurately performing instruction optimization.

Furthermore, different duration scene observation periods can be set for different users to adapt to the device usage habits of different users. For example, if User A quickly performs additional manual controls on the smart device when the target scene does not meet expectations, then the duration of their scene observation period can be set shorter; on the contrary, if User B waits for a period before performing additional manual controls on the smart device when the target scene does not meet expectations, then the duration of their scene observation period can be set longer. Thereby, based on setting a scene observation period that better conforms to the device usage habits of different users, a better understanding of the true intentions of different users is achieved, making the instruction optimization function more intelligent.

Of course, the computing device can always detect whether the corresponding device control commands need to be updated when the target scene is triggered, and can also update the device control commands when the target scene is triggered based on the indication. In one possible implementation, the indication is achieved by whether the instruction optimization function is enabled, where enabling the instruction optimization function means allowing updates to the device control commands when the target scene is triggered. Specifically, detect whether the instruction optimization function is enabled: if the instruction optimization function is detected to be enabled, it indicates that updates to the device control commands when the target scene is triggered are allowed, then obtain the scene steady-state set of the target scene to subsequently detect whether the corresponding device control commands need to be updated based on the scene steady-state set of the target scene; otherwise, if the instruction optimization function is detected to be disabled, it indicates that updates to the device control commands when the target scene is triggered are not allowed, then there is no need to obtain the scene steady-state set of the target scene, directly send the device control commands to the corresponding smart device, enabling the smart device to execute the corresponding initial actions.

In this manner, the instruction optimization function can be flexibly set to be enabled or disabled according to the actual needs of the application scene. For example, in an application scene with limited resources, the instruction optimization function can be turned off, at this time, the scene steady-state set of the target scene is not obtained to avoid performing calculations for instruction optimization, thus reducing resource occupancy.

It should be noted that the smart device executing additional actions during a single scene observation period can indicate that the initial actions executed by the smart device after the target scene is triggered this time do not meet the user's expectations, but it does not mean that the user is dissatisfied with the configuration of the target scene. For example, if the weather suddenly gets cold and the target scene includes device control commands for turning on the air conditioner's cooling mode, after the target scene is triggered, the user manually controls the air conditioner to raise the temperature during the scene observation period, and this sudden cold weather is a temporary temperature change, the user's operation is only for this triggered target scene. That is to say, based on the number of times and/or frequency the smart device executes additional actions during multiple scene observation periods, it can represent whether the user is satisfied with the configuration of the target scene, and thus it is possible to decide whether to perform instruction optimization.

Based on this, in one possible implementation, whether to update the device control commands triggered by the target scene can be judged by the satisfaction of the target scene, specifically, it can include the following steps: determine the satisfaction of the target scene based on the frequency of the smart device executing additional actions during multiple scene observation periods; if the satisfaction of the target scene indicates that the device control commands triggered by the target scene need to be updated, then obtain the scene steady-state set of the target scene.

Wherein, the satisfaction is used to indicate the frequency of the smart device executing additional actions during multiple scene observation periods, which can refer to the number of times and/or frequency. For example, in terms of the number of times, if the smart device executes additional actions 2 times during 10 scene observation periods, the satisfaction is 80%, and if the smart device executes additional actions 8 times during 10 scene observation periods, the satisfaction is 20%.

It should be understood that the higher the frequency of the smart device executing additional actions during multiple scene observation periods, the lower the satisfaction of the target scene, which indicates a greater need to update the device control commands triggered by the target scene. For example, when the satisfaction of the target scene is 50%, the device control commands triggered by the target scene can be updated, or they can be left unchanged; when the satisfaction of the target scene is 20%, there is a need to update the device control commands triggered by the target scene, otherwise, the initial actions configured for the smart device in the target scene may not meet the user's expectations.

Based on this, a threshold can be set for satisfaction, and when the satisfaction is below this threshold, it is determined that the device control commands triggered by the target scene need to be updated. Specifically, this threshold can be set manually by the user or set by the server based on big data analysis calculations, without specific limitation here.

In summary; using the satisfaction of the target scene to determine whether to update the device control commands when the target scene is triggered, on the one hand, it allows for timely updates to the device control commands when they do not meet the requirements, making the target scene more practical and in line with actual needs; on the other hand, it avoids obtaining and analyzing the scene steady-state set every time the smart device performs additional actions, which can effectively reduce the amount of calculation and save resources.

Step 350C, updating the device control command when a target scene is triggered based on the first device parameter and the second device parameters in the scene steady-state set.

Wherein, the device control commands are used to indicate the corresponding initial actions to be executed by the smart device.

It should be noted that since the second device parameters are obtained by the smart device performing additional actions during a scene observation period, the second device parameters in the scene steady-state set can reflect the user's device usage habits. Moreover, the first device parameters are generated by the smart device executing the initial actions configured in the target scene. In other words, the first device parameters are related to the device control commands triggered when the target scene is triggered. Therefore, it is possible to update the device control commands triggered by the target scene based on the first device parameters and the second device parameters in the scene steady-state set.

For example, target scene A includes multiple device control commands such as turning on the living room air conditioner cooling mode, turning on the living room light, and turning on the living room TV. If the living room TV is turned off multiple times during the scene observation period after target scene A is triggered multiple times, then the scene observation period will record the second device parameter of the living room TV being turned off. When optimizing the instructions, the computing device can update the device control commands corresponding to target scene A based on the aforementioned second device parameter. That is to say; the new device control command of “turn off the living room TV” can be used to update the “turn on the living room TV” device control command in target scene A.

Of course, the target scene is configured based on the linkage of multiple smart devices. If, after the target scene is triggered, the user manually controls multiple smart devices configured in the target scene during the scene observation period to perform additional actions, correspondingly, multiple second device parameters will be obtained. Each second device parameter corresponds to different additional actions performed by different smart devices during the scene observation period. In one possible implementation, based on the second device parameters corresponding to each smart device during multiple scene observation periods, update the device control commands corresponding to the target scene when it is triggered. It is understood that based on the second device parameters corresponding to each smart device during multiple scene observation periods, the computing device can directly update the device control commands corresponding to the target scene when it is triggered, obtaining the updated target scene. Alternatively, the update content of the target scene can be obtained based on the second device parameters, and then the update content of the target scene can be pushed to the user for confirmation. After obtaining the user's confirmation instruction, the device control commands corresponding to the target scene when it is triggered can be updated.

Still taking target scene A as an example, if the living room TV is turned off multiple times and the living room air purifier is turned on multiple times during the scene observation period after A is triggered multiple times, then the computing device can separately base on the second device parameters corresponding to the living room TV and the living room air purifier. That is to say, the new device control command of “turn off the living room TV” can be used to update the “turn on the living room TV” device control command in target scene A. In addition, a new device control command of “turn on the living room air purifier” can also be added for target scene A.

After completing the instruction optimization for the target scene, when the target scene is triggered, the updated device control commands can be sent to the corresponding smart devices, enabling the smart devices to respond to the updated device control commands and execute the initial actions.

Through the above process, on the one hand, the scene steady-state set includes the second device parameters generated during multiple scene observation periods. Updating the target scene based on the scene steady-state set can make the target scene more suitable for the actual situation, thereby making the device control based on the target scene more in line with the user's true intentions. On the other hand, when the target scene deviates from the actual situation, automatically updating the device control commands triggered by the target scene based on the first device parameters and the second device parameters in the scene steady-state set can reduce the steps for the user to modify the target scene configuration, making the instruction optimization operation simple and not cumbersome, thereby increasing the user experience.

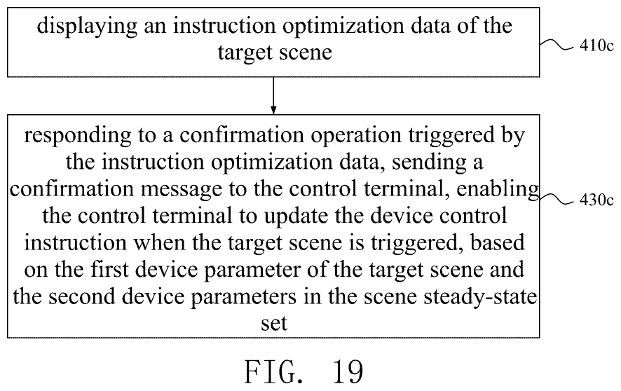

Please refer to FIG. 18. In one exemplary implementation, step 350C may include the following steps:

Step 351C, performing feature processing on an environmental parameter when the target scene is triggered to obtain an environmental state corresponding to the target scene.

Wherein, the environmental parameters are used to indicate the actual environmental conditions when the target scene is triggered. Regarding the acquisition of environmental parameters, they can be obtained by smart sensors configured in the Internet of Things, or they can be obtained by smart devices configured in the target scene, without specific limitation. For example, the temperature sensor in the Internet of Things detects the actual environmental temperature value as 26° C., and the humidity sensor detects the actual relative humidity value as 75%.

Regarding feature processing, it refers to determining the actual environmental characteristics of the target scene for different environmental parameters, that is, transforming continuous environmental parameters into discrete environmental states, making the environmental parameters have obvious characteristic expressions. For example, for the time in the environmental parameters, the continuous time points are transformed into discrete time periods; morning (6:00 to 11:00), noon (11:00 to 13:00), afternoon (13:00 to 19:00), evening (19:00 to 1:00), and early morning (1:00 to 6:00); for example, for the temperature value in the environmental parameters, the continuous temperature values are transformed into discrete temperature expressions: low temperature (below 18° C.), comfortable (18° C.-26° C.), and high temperature (above 26° C.).

Step 353C, clustering the second device parameters in the scene steady-state set according to an obtained environmental state to obtain a third device parameter for the corresponding environmental state.

Wherein, the third device parameters are related to the actions expected to be executed by the smart device in the corresponding environmental state.

It can be understood that if the computing device classifies the second device parameters in the scene steady-state set for each environmental parameter, since the environmental parameters when the target scene is triggered each time are difficult to be completely consistent, the number of environmental parameters is large, and the number of second device parameters under one environmental parameter is limited, it is difficult to determine the corresponding third device parameter for one of the environmental parameters; moreover, since the number of second device parameters corresponding to one environmental parameter is small, it is difficult to discover the user's device usage habits based on a few second device parameters, and the obtained third device parameters cannot reflect the user's true intentions, which will cause the instruction optimization result to be inaccurate.

Based on this, by using environmental parameters for feature processing to obtain the environmental state of the target scene, since the environmental state corresponds to multiple environmental parameters, there are more second device parameters under this environmental state. Therefore, by classifying the second device parameters under this environmental state, it is possible to fully explore the user's device usage habits under this environmental state, making the obtained third device parameters able to restore the user's true intentions, in order to improve the practicality of the target scene and enhance the user experience.

It should be noted that clustering methods such as hierarchical method, density algorithm, graph theory clustering method, and grid algorithm can be used to classify the second device parameters in the scene steady-state set, without specific limitation here.

For example, under environmental state A, the second device parameters in the scene steady-state set include a, a, a, a, a, a, b, b, c, c, c, d, and under environmental state B, the second device parameters in the scene steady-state set include a, a, a, b, b, b, b, b, c, d, d, where different letters represent different additional actions performed by the smart device; classifying the second device parameters under environmental state A, the classification result is a, and a is the third device parameter for environmental state A. Classifying the second device parameters under environmental state B, the classification result is b, and b is the third device parameter for environmental state B.

It should be noted that the target scene may be triggered under different environmental states, so there may be multiple environmental states corresponding to the target scene. It can be understood that the additional actions performed by the smart devices configured in the target scene under different environmental states may reflect the user's device usage habits under different environmental states.

Therefore, in order to understand the user's device usage habits under different environmental states and make the device control commands triggered by the target scene more in line with the user's true intentions, in one possible implementation, clustering the second device parameters in the scene steady-state set may also include the following steps: when there are multiple environmental states corresponding to the target scene, determine the scene steady-state sets under various environmental states: for each environmental state, classify the second device parameters in the determined scene steady-state set to obtain the third device parameters under the corresponding environmental state.

Wherein, the third device parameters under each environmental state can be regarded as the actions that the user expects the configured smart devices in the target scene to perform when the target scene is triggered under that environmental state. Of course, if the third device parameters obtained under various environmental states are the same, it can indicate that there is no difference in the actions that the user expects the smart devices in the target scene to perform between various environmental states, that is, the user's device usage habits are the same under different environmental states. Conversely, if the third device parameters under various environmental states are different, it can indicate that there are differences in the actions that the user expects the smart devices in the target scene to perform under various environmental states, that is, the user's device usage habits are also different under different environmental states.

Based on this, in one possible implementation, detect whether the third device parameters under various environmental states are the same: if not, create or push new scenes based on the third device parameters under various environmental states.

It should be noted that the computing device can directly create new scenes based on the third device parameters under various environmental states, or it can push them to the user for the user to decide whether to create new scenes, without specific limitation here.

In one possible implementation, the creation of new scenes is determined by the user, which can include the following steps: receive feedback messages for the creation of new scenes: if the feedback message indicates permission to create new scenes, then create new scenes based on the third device parameters and store the created new scenes, and update the device control commands when the new scenes are triggered based on the third device parameters of the new scenes.

It can be understood that the created new scenes can cover the actions that the user expects the smart devices to perform under various environmental states. In short, the created new scenes can meet actual needs and conform to the user's true intentions under different environmental states. The created new scenes can be one or multiple, depending on the situation of the third device parameters.

Step 355C, updating the device control command when the target scene is triggered based on the third device parameter for the corresponding environmental state and the first device parameter.

It should be noted that the third device parameters under the corresponding environmental state can be regarded as the actions that the user expects the corresponding smart devices to perform when the target scene is triggered under that environmental state. Based on this, the third device parameters can be used to update the corresponding device control commands in the target scene.

In one possible implementation, updating the device control commands triggered by the target scene can include the following steps: compare the differences between the third device parameters and the first device parameters under the corresponding environmental state, obtain the comparison results: update the device control commands triggered by the target scene based on the comparison results. For example, the first device parameters indicate that the living room air conditioner is turned on, the working mode is cooling at 24° C., the living room light is turned on, and the living room TV is turned on, and the third device parameters indicate that the living room air conditioner is turned on, the working mode is cooling at 22° C., the living room light is turned on, and the living room TV is turned on: compare the two, and the comparison result indicates that there is a difference in the action performed by the living room air conditioner between the first device parameters and the third device parameters, thus updating the device control commands triggered by the target scene based on this comparison result.

It should be noted that the third device parameters are obtained by clustering the second device parameters. If the second device parameters appear infrequently, for example, the target scene has been triggered 20 times, and the scene steady-state set records the second device parameters as a, b, b, b, c, d, where different letters represent different additional actions of the smart device. If the above second device parameters are clustered, and the clustering result is the third device parameter b, it should be understood that although b is the clustering result, the target scene has been triggered 20 times, and b has only appeared 3 times, which means that the clustering result is not significant. If the device control commands triggered by the target scene are updated based on the third device parameter b, it will cause the target scene not to conform to the user's true intentions.

Based on this, in one possible implementation, before updating the device control commands triggered by the target scene according to the third device parameters, the following steps may also be included: determining the confidence level corresponding to the third device parameters under the corresponding environmental state: if the confidence level meets the set conditions, then comparing the differences between the third device parameters and the first device parameters under the corresponding environmental state, and updating the device control commands triggered by the target scene based on the third device parameters and the first device parameters under the corresponding environmental state.

Wherein, the confidence level is determined based on the number of times the third device parameters appear within a preset time period, or based on the ratio between the number of times the third device parameters appear within a preset time period and the number of times the target scene is triggered. It should be understood that when the confidence level of the third device parameters meets the set conditions, it indicates that the third device parameters conform to the user's true intentions.

For example, the set condition is: the target scene is triggered more than 10 times within half a month, and the confidence level indicates that the ratio of the number of times the third device parameters appear in the target scene to the number of times the target scene is triggered is greater than 30%. If the confidence level of the third device parameters meets the above set conditions, then the differences between the third device parameters and the first device parameters under the corresponding environmental state can be compared, and the device control commands triggered by the target scene can be updated based on the third device parameters.

Under the effect of the above embodiment, on the one hand, the third device parameters obtained by clustering the second device parameters in the scene steady-state set can explore the user's device usage habits, thereby making the updated target scene more in line with the user's true intentions. On the other hand, by pushing or creating new scenes based on the third device parameters under various environmental states, proactive suggestions for instruction optimization under various environmental states can be provided to users, which not only enhances the practicality of device control based on scenes but also greatly improves the user experience.

Please refer to FIG. 19. This public embodiment provides a device processing method, as shown in FIG. 19, the method can include the following steps:

Step 410C, displaying an instruction optimization data of the target scene.

Wherein, the target scene is a device control method configured based on the linkage of multiple smart devices, and the target scene can include one or more device control commands: the instruction optimization data is used to indicate the updated device control commands, which are determined by the control terminal based on the first device parameters of the target scene and the second device parameters in the scene steady-state set. In one embodiment, the control terminal can be a server terminal or a gateway, and the server terminal can also be considered as a cloud, cloud platform, platform end, service end, etc.

Step 430C, responding to a confirmation operation triggered by the instruction optimization data, sending a confirmation message to the control terminal, enabling the control terminal to update the device control command when the target scene is triggered, based on the first device parameter of the target scene and the second device parameters in the scene steady-state set.

Wherein, the first device parameters are generated by the smart device executing the initial actions configured in the target scene, used to indicate the device state of the smart device; the scene steady-state set includes the second device parameters generated during multiple scene observation periods; the second device parameters are generated by the smart device executing additional actions during a single scene observation period. The updated device control commands are determined by the control terminal based on the first device parameters of the target scene and the second device parameters in the scene steady-state set.

Regarding the confirmation message, it is used to confirm the update of the device control commands when the target scene is triggered. This confirmation message can be triggered by the user's operation on the user terminal, causing the user terminal to send the confirmation message to the control terminal, without specific limitation here.

Optionally, the user can choose whether to update the device control commands when the target scene is triggered. In one possible implementation, in response to the activation operation triggered by the instruction optimization function, request the control terminal to mark that the instruction optimization function is enabled. The enabling of the instruction optimization function refers to allowing the device control commands to be updated when the target scene is triggered.

Through the above process, the instruction optimization data is displayed, providing the user with suggestions for instruction optimization. If the user confirms the update, the control terminal will update the device control commands triggered by the target scene. The user does not need excessive operations, only needing to trigger the confirmation operation, with the remaining steps of instruction optimization automatically executed by the control terminal, reducing the complexity of instruction optimization and thereby enhancing the user experience.

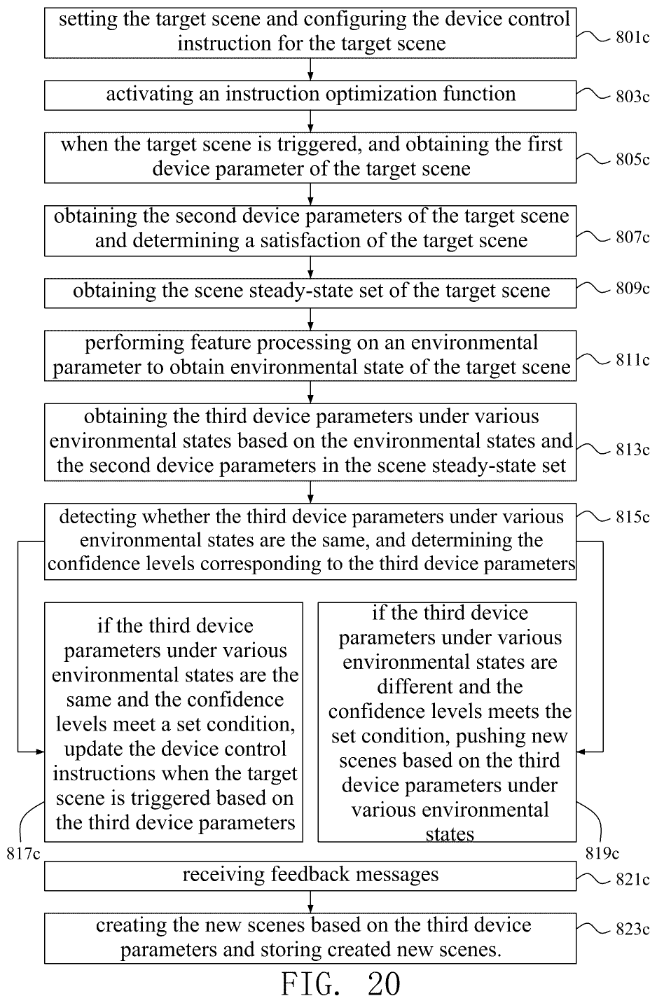

FIG. 20 is a specific implementation schematic diagram of a device processing method in an application scene. In this application scene, the device processing method provided by this embodiment is executed by a computing device, which can be the server terminal 170 shown in the aforementioned FIG. 1, or it can also be the gateway 150.

As shown in FIG. 20, the device processing method in this application scene can include the following steps:

Through step 801C, setting the target scene and configuration the device control command for the target scene.

Through step 803C, activating an instruction optimization function.

Through step 805C, when the target scene is triggered, and obtaining the first device parameter of the target scene.

Through step 807C, obtaining the second device parameters of the target scene and determining a satisfaction of the target scene.

If the satisfaction indicates that the device control command need to be updated when the target scene is triggered, then through step 809C, obtaining the scene steady-state set of the target scene.

Through step 811C, performing feature processing on an environmental parameter to obtain environmental state of the target scene

Through step 813C, obtaining the third device parameters under various environmental states based on the environmental states and the second device parameters in the scene steady-state set.

Through step 815C, detecting whether the third device parameters under various environmental states are the same, and determining the confidence levels corresponding to the third device parameters.

Through step 817C, if the third device parameters under various environmental states are the same and the confidence levels meet a set condition, update the device control commands when the target scene is triggered based on the third device parameters.

Through step 819C, if the third device parameters under various environmental states are different and the confidence levels meets the set condition, pushing new scenes based on the third device parameters under various environmental states.

Through step 821C, receiving feedback messages.

If the feedback message indicates permission to create a new scene, through step 823C, creating the new scenes based on the third device parameters and storing created new scenes.

In this application scene, first, as long as the user turns on the instruction optimization function, it will automatically optimize the instructions for the target scene, reducing the steps of instruction optimization: second, determine whether to obtain the scene steady-state set based on the satisfaction of the target scene, which can achieve instruction optimization calculations only when the target scene deviates from the actual situation, saving resources; third, update the device control commands only when the confidence level of the third device parameters meets the set conditions, avoiding incorrect instruction optimization, making the results of instruction optimization more accurate; fourth, obtain the third device parameters under various environmental states based on environmental parameters and the scene steady-state set, making instruction optimization more intelligent, providing users with suggestions for creating new scenes, increasing the practicality of device control using scenes, and enhancing the user experience.

It should be understood that although the various steps in the flowcharts of the aforementioned embodiments are sequentially displayed according to the arrows, these steps are not necessarily executed in the order indicated by the arrows. Unless explicitly stated in this document, there is no strict order restriction on the execution of these steps, and these steps can be executed in other orders. Moreover, at least some of the steps in the aforementioned embodiments can include multiple steps or stages, and these steps or stages are not necessarily executed at the same time, but can be executed at different times. The execution order of these steps or stages is not necessarily sequential, but can be executed in rotation or alternation with at least some of the other steps or stages in other steps.

In one embodiment, a system for configuration devices is provided, which includes:
a terminal device, configured to display an application interface that includes recommendation configuration prompt information, wherein the recommendation configuration prompt information is configured to prompt users to view suggestions for device configuration: respond to receive selection operations for the recommendation configuration prompt information, control a displaying module to display at least one device configuration item for a smart device; respond to a confirmation operation for at least one target device configuration item in the device configuration items of the smart device, configure the smart device corresponding to the target device configuration item based on the target device configuration item;
a server, configured to obtain a usage data of the smart device by users within a preset time period, generate device configuration items based on the usage data of the smart device by users within the preset time period, each device configuration item including recommended control operations for the smart device and times for executing the control operations.

Optionally, the terminal device is also configured to receive a update operation for the selected target device configuration item, update the device configuration item based on the update operation: responsive to a confirmation operation on the updated selected target device configuration item, configuration the corresponding device based on the target device configuration item.

Optionally, the historical device operation data includes control operations of devices under the target space and execution parameters of the control operations within the target time period; the terminal device is also configured to analyze and process the control operations and execution parameters of the control operations of each device under the target space within the target time period, to obtain device configuration recommendation information.

Optionally, the terminal device is also configured to, for each device under the target space within the target time period, when the execution frequency of the control operation within the target time period is greater than or equal to the frequency threshold, determine the control operation as the pending analysis control operation; analyze the execution parameters of the pending analysis control operation, to obtain the target control operation and the target execution time corresponding to the target control operation; based on the target control operation and the target execution time corresponding to the target control operation, obtain the device configuration recommendation information.

Optionally, the terminal device is also configured to obtain the expected time of execution times of the pending analysis control operations; obtain the differences between the expected time and the execution times of all the pending analysis control operations; when the number of differences less than a preset time difference accounts for a proportion greater than or equal to a preset proportion threshold of the total number of differences, determine the pending analysis control operation as the target control operation, and determine the expected time of the execution times of pending analysis control operations as target execution time corresponding to the target control operation.

Optionally, the terminal device is also configured to obtain user habit data within the target time period; by analyzing the correlation between the user habit data and the control operations of devices under the target space and the execution parameters of the control operations within the target time period, determine the device configuration recommendation information corresponding to the user habit data.

Optionally, the terminal device displays the recommendation configuration prompt information on the application interface, including: the terminal device responds to the application startup command, starts the application, and displays the recommendation configuration prompt information on the home page of the application.

Optionally, the terminal device is also configured to, after completing a control interaction, determine when there are any device configuration items that the user has not viewed in the application currently; output voice prompt information, the voice prompt information is configured to prompt the user to view suggestions for device configuration.

Optionally, after the terminal device displays at least one device configuration item for smart devices, it also includes: the terminal device responds to selection operations on the device configuration items, displays the configuration interface corresponding to the device configuration items: the terminal device receives update operations on the control operations and/or execution times of the control operations in the configuration interface, updates the device configuration items based on the update operations; the terminal device receives confirmation operations on the device configuration items in the configuration interface.

Optionally; the usage data includes control operations and execution times of the control operations; the server is also configured to generate device configuration items based on the control operations of smart devices by users, execution times of the control operations, and frequency thresholds within the preset time period.

Optionally, the server is also configured to adjust the frequency thresholds based on update operations.

It can be understood that the system provided in this embodiment has similar implementation principles and technical effects as the system in the aforementioned embodiments.

The following is an embodiment of the device of the disclosure, which can be used to perform the device processing method covered by the disclosure. For details not disclosed in the device embodiment of the disclosure, refer to the method embodiment of the device processing method covered by the disclosure.

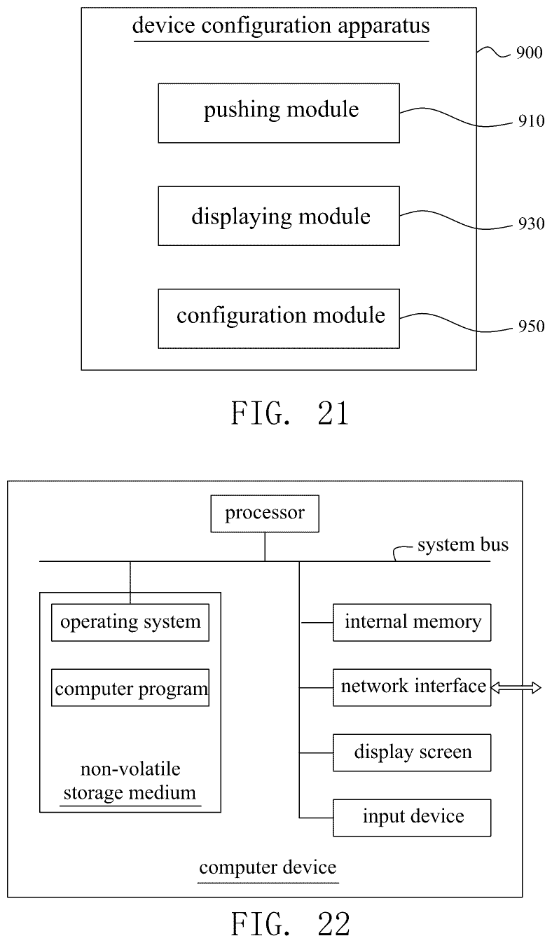

In one embodiment, please refer to FIG. 21, a device configuration apparatus 900 is provided by one embodiment, which includes:
a pushing module 910, for when obtaining device configuration recommendation information for a device under a target space, pushing and displaying the device configuration recommendation information: wherein the device configuration recommendation information is obtained by analyzing a historical device operation data;
a displaying module 930, for responding to a selection operation for at least one device configuration item in the device configuration recommendation information, displaying device control information corresponding to a selected target device configuration item;
a configuration module 950, for responding to a configuration operation for the selected target device configuration item, performing configuration processing on a corresponding device based on a target device configuration item, to apply the target device configuration item.

Optionally, the device also includes:
a voice interaction module, configured to detect whether there are any unviewed device configuration items currently after completing a voice interaction; when there is an unviewed device configuration item currently, output voice prompt information, wherein the voice prompt information is configured to prompt the user to view the device configuration item.

Optionally, the configuration module 950 is specifically configured to:
receive an update operation for the selected target device configuration item, update the device configuration item based on the update operation; respond to a confirmation operation for an updated selected target device configuration item, perform configuration processing on the corresponding device based on the target device configuration item.

Optionally; the historical device operation data includes: control operations of devices under the target space and execution parameters of the control operations within a target time period, the device also includes:
a device configuration recommendation information generation module, configured to analyze and process the control operations and execution parameters of the control operations of each device under the target space within the target time period, to obtain device configuration recommendation information.

Optionally, the device configuration recommendation information generation module is specifically configured to:
for each control operation of each device under the target space within the target time period, when the execution frequency of the control operation within the target time period is greater than or equal to the frequency threshold, determine the control operation as the pending analysis control operation; analyze the execution parameters of the pending analysis control operation, to obtain the target control operation and the target execution time corresponding to the target control operation; based on the target control operation and the target execution time corresponding to the target control operation, obtain the device configuration recommendation information.

Optionally, the device configuration recommendation information generation module is specifically configured to:
obtain the expected execution time of the pending analysis control operation; obtain the differences between the expected time and the execution times of all the pending analysis control operations; when the number of differences less than the preset time difference accounts for a proportion greater than or equal to a preset proportion threshold of the total number of differences, determine the pending analysis control operation as the target control operation, and determine the expected time of the execution times of the pending analysis control operations as the target execution time corresponding to the target control operation.

Optionally, the device configuration recommendation information generation module is also configured to:
obtain a user habit data within the target time period; by analyzing the correlation between the user habit data and the control operations of devices under the target space and the execution parameters of the control operations within the target time period, determine the device configuration recommendation information corresponding to the user habit data.

In one embodiment, the device processing apparatus provided herein includes a log obtaining module, a requirement determination module, and a plan generation module. The device configuration recommendation information includes scene configuration plans for target scenes.

The log obtaining module is configured to obtain historical device operation data, which records at least the operational attributes of the device. The operational attributes are configured to indicate at least one of the actions performed by the device, the state of the device after performing the action, and the time of performing the action. In one implementation, the operational attributes include control operations of the device and the execution parameters of the control operations within a target time period and in a target space. The execution parameters can include execution time and/or execution frequency.

The requirement determination module is configured to determine device configuration requirements for a target scene based on the operational attributes recorded in the historical device operation data. The device configuration requirements are configured to indicate that at least one device needs to configure corresponding actions in the target scene.

The plan generation module is configured to generate a scene configuration plan for the target scene based on the device configuration requirements, enabling at least one device to perform corresponding actions configured according to the scene configuration plan when executing in the target scene.

In an exemplary embodiment, the requirement determination module includes a new action determination module. This module is configured to determine whether at least one device has performed a new action after the execution of a configured target scene, based on the operational attributes recorded in the historical device operation data. A new action is distinct from the actions configured for the device in the already configured target scene. If so, it notifies a first requirement determination module, which is configured to consider the new action performed by at least one device as a device configuration requirement for the already configured target scene, indicating that at least one device needs to reconfigure corresponding new actions in the already configured target scene.

In an exemplary embodiment, the new action determination module includes a frequency determination module. This module is configured to determine the frequency of a new action performed by a device within a first predetermined duration, based on the operational attributes recorded in the historical device operation data. The first predetermined duration refers to the time period during which the configured target scene is executed multiple times consecutively. If the frequency exceeds a frequency threshold, it notifies a single device determination module, which is configured to identify that a device has performed a new action.

In an exemplary embodiment, the new action determination module includes a quantity determination module. This module is configured to determine the number of devices that have performed a new action after the execution of a configured target scene, based on the operational attributes recorded in the historical device operation data. If the quantity exceeds a quantity threshold, it notifies a multiple devices determination module, which is configured to identify that multiple devices have performed a new action.

In an exemplary embodiment, the requirement determination module includes a multiple actions determination module. This module is configured to determine whether multiple devices have performed actions within a second predetermined duration, based on the operational attributes recorded in the historical device operation data. The second predetermined duration refers to the time period during which multiple devices perform actions consecutively; If so, it notifies a second requirement determination module, which is configured to consider the corresponding actions performed by multiple devices as device configuration requirements for the target scene, indicating that multiple devices need to configure corresponding actions in the target scene.

In an exemplary embodiment, the plan generation module includes an attribute creation module. This module is configured to create scene configuration attributes for devices in the target scene based on the actions that devices need to configure according to the device configuration requirements. The scene configuration attributes indicate the actions that devices should configure in the target scene. A first plan generation module is configured to generate a scene configuration plan based on the scene configuration attributes created for each device in the target scene.

In an exemplary embodiment, the plan generation module includes an attribute obtaining module. This module is configured to acquire scene configuration attributes that have been created for devices in the target scene. An attribute adjustment module is configured to adjust the scene configuration attributes for devices in the target scene based on the actions that devices need to configure according to the device configuration requirements. A second plan generation module is configured to generate a scene configuration plan based on the adjusted scene configuration attributes for each device in the target scene.

In an exemplary embodiment, the apparatus further includes a message pushing module. This module is configured to generate and push configuration prompt information to notify users to confirm whether to configure the target scene according to the scene configuration plan. A scene configuration module is configured to configure corresponding actions for at least one device in the target scene based on the confirmed scene configuration plan. A device control module is configured to control at least one device to perform corresponding actions configured according to the scene configuration plan when executing in the target scene.

In one implementation, the device configuration recommendation information includes device control commands corresponding to the target scene.

The present disclosure also provides another device processing apparatus that includes, but is not limited to: a first parameter obtaining module, a second parameter obtaining module, and a command update module.

The first parameter obtaining module is used to obtain the first device parameters for the configured target scene, which are generated by the initial actions configured for the smart device to execute in the target scene. In one implementation, the first device parameters are generated based on the device configuration recommendation information configured by the initial actions, which is generated from historical device operation data under the target scene. The historical device operation data may include control operations of the device and execution parameters of the control operations within a target time period and in a target space. Specifically, the first device parameters can be generated after the smart device executes actions corresponding to the control operations and execution parameters.

The second parameter obtaining module is used to obtain the scene steady-state set of the target scene, which includes the second device parameters generated during multiple scene observation periods; each second device parameter is generated by the smart device executing an additional action during a single scene observation period.

The command update module is used to update the device control command when the target scene is triggered, based on the first device parameter and the second device parameters in the scene steady-state set; the device control command is used to instruct the smart device to execute the corresponding initial action.

In an exemplary embodiment, the command update module includes characterization unit for performing feature processing on an environmental parameter when the target scene is triggered, to obtain an environmental state corresponding to the target scene; a clustering unit for clustering the second device parameters in the scene steady-state set according to an obtained environmental state to obtain a third device parameter for corresponding environmental state; and an update unit for updating the device control command when the target scene is triggered based on the third device parameter for the corresponding environmental state and the first device parameter.

In an exemplary embodiment, the command update module is also used to compare the differences between the third device parameters for the corresponding environmental state and the first device parameters to obtain the comparison results; and update the device control commands when the target scene is triggered based on the comparison results.

In an exemplary embodiment, the command update module is also used to determine the confidence level corresponding to the third device parameters for the corresponding environmental state: the confidence level is determined based on the number of times the third device parameters appear within a preset time period; if the confidence level meets the set condition, then update the device control commands when the target scene is triggered based on the third device parameters for the corresponding environmental state and the first device parameters.

In an exemplary embodiment, the command update module is also used to determine the confidence level based on the ratio of the number of times the third device parameters appear within a preset time period to the number of times the target scene is triggered.

In an exemplary embodiment, the command update module is also used to determine the scene steady-state sets for various environmental states when there are multiple environmental states corresponding to the target scene; and cluster the second device parameters in the determined scene steady-state set for each environmental state to obtain the third device parameter for the corresponding environmental state.

In an exemplary embodiment, the command update module is also used to detect whether the third device parameters for various environmental states are the same: if not, then push a new scene based on the third device parameter for each environmental state.

In an exemplary embodiment, the command update module is also used to create a new scene based on the third device parameter for each environmental state if it is detected that the third device parameters for various environmental states are not the same.

In an exemplary embodiment, the command update module is also used to receive feedback messages for the creation of a new scene; if the feedback message indicates that the creation of a new scene is allowed, then create a new scene based on the third device parameter and store the created new scene to update the device control command for the new scene when triggered.

In an exemplary embodiment, the device processing apparatus is also used to determine the satisfaction of the target scene based on the frequency with which the smart device executes additional actions during multiple scene observation periods; if the satisfaction of the target scene indicates that the device control commands when the target scene is triggered need to be updated, then obtain the scene steady-state set for the target scene.

In an exemplary embodiment, the device processing apparatus is also used to determine the feedback volume for the scene observation period within a set time period; the feedback volume is used to indicate the number of times the smart device executes additional actions detected during the scene observation period; adjust the scene observation period based on the feedback volume.

In an exemplary embodiment, the device processing apparatus is also used to send the updated device control commands to the corresponding smart device when the target scene is triggered, so that the smart device executes the initial actions in response to the updated device control commands.

In an exemplary embodiment, the device processing apparatus is also used to detect whether the command optimization function is enabled: the enabling of the command optimization function means allowing the device control commands when the target scene is triggered to be updated: if it is detected that the command optimization function is enabled, then obtain the scene steady-state set for the target scene.

The present disclosure also provides another device processing apparatus that includes, but is not limited to: a data displaying module and a message sending module.

The data displaying module is used to display the command optimization data for the target scene, which indicates the device control command after the update processing: the updated device control command is determined by the control terminal based on the first device parameter for the target scene and the second device parameters in the scene steady-state set; the first device parameter is generated by the smart device executing the initial action configured for the target scene and is used to indicate the device state of the smart device; the scene steady-state set includes the second device parameters for multiple scene observation periods; the second device parameters are generated by the smart device executing additional actions during a single scene observation period.

The message sending module is used to send a confirmation message to the control terminal in response to a confirmation operation triggered by the command optimization data, so that the control terminal updates the device control commands when the target scene is triggered.

In an exemplary embodiment, the device processing apparatus is also used to request the control terminal to mark the command optimization function as enabled in response to an operation triggered by the command optimization function.

In one embodiment, a computer device is provided, which can be a terminal, and its internal structure can be as shown in FIG. 22. The computer device includes a processor, memory, a network interface, a display; and an input device connected through a system bus. The processor of the computer device is configured to provide computing and control capabilities. The memory of the computer device includes non-volatile storage media and internal memory. The non-volatile storage media stores an operating system and computer-readable instructions. The internal memory provides an environment for the operation of the operating system and computer-readable instructions stored on the non-volatile storage media. The network interface of the computer device is used for network communication with external terminals. The computer-readable instructions, when executed by the processor, implement a method for configuration devices. The display of the computer device can be a liquid crystal display or an electronic paper display, and the input device of the computer device can be a touch layer covering the display; or buttons, a trackball, or a touchpad set on the casing of the computer device, or external keyboards, touchpads, or mice, etc.

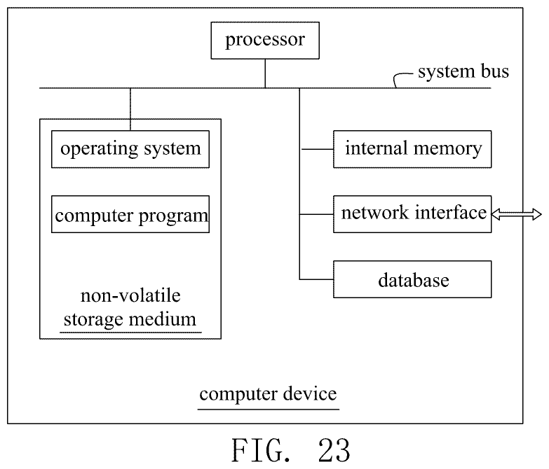

In another embodiment, a computer device is provided, which can be a server, and its internal structure can be as shown in FIG. 23. The computer device includes a processor, memory, a network interface, and a database connected through a system bus. The processor of the computer device is configured to provide computing and control capabilities. The memory of the computer device includes non-volatile storage media and internal memory. The non-volatile storage media stores an operating system, computer-readable instructions, and a database. The internal memory provides an environment for the operation of the operating system and computer-readable instructions stored on the non-volatile storage media. The database of the computer device is configured to store usage data and device configuration item data. The network interface of the computer device is used for network communication with external terminals. The computer-readable instructions, when executed by the processor, implement a method for configuration devices.

It is understood by those skilled in the art that the structures shown in FIGS. 22 and 23 are merely block diagrams of parts of the structures related to the present application and do not constitute a limitation on the computer devices to which the present application is applied. The specific computer devices may include more or fewer components than those shown in the FIGS., or combine certain components, or have different component arrangements.

In one embodiment, a computer device is provided, including at least one processor and at least one memory, wherein the memory stores computer-readable instructions: when the computer-readable instructions are executed by the processor, the electronic device implements the steps of the various method embodiments described above.

In one embodiment, a computer-readable storage medium is provided, on which computer-readable instructions are stored, and when the computer-readable instructions are executed by one or more processors, the one or more processors implement the steps of the various method embodiments described above.

In one embodiment, a computer program product or a computer program is provided, which includes computer-readable instructions, and the computer-readable instructions are stored on a computer-readable storage medium. The processor of the computer device reads the computer-readable instructions from the computer-readable storage medium, and when the processor executes the computer-readable instructions, the computer device performs the steps of the various method embodiments described above.

It is understood by those skilled in the art that all or part of the processes in the above embodiments can be implemented by instructing the relevant hardware with computer-readable instructions. The computer-readable instructions can be stored on a non-volatile computer-readable storage medium, and when executed, can include the processes of the various method embodiments described above. Any reference to memory, storage, databases, or other media in the embodiments provided in this application may include both non-volatile and/or volatile memory. Non-volatile memory may include Read-Only Memory (ROM), Programmable ROM (PROM), Erasable Programmable ROM (EPROM), Electrically Erasable Programmable ROM (EEPROM), or flash memory. Volatile memory may include Random Access Memory (RAM) or external high-speed cache memory. By way of illustration and not limitation, RAM is available in various forms, such as Static RAM (SRAM), Dynamic RAM (DRAM), Synchronous DRAM (SDRAM), Double Data Rate SDRAM (DDR SDRAM), Enhanced SDRAM (ESDRAM), Synchronous Link (Synchlink) DRAM (SLDRAM), Memory Bus Direct RAM (RDRAM), Direct Memory Access Bus Dynamic RAM (DRDRAM), and Memory Bus Dynamic RAM (RDRAM), etc.

The various technical features of the above embodiments can be combined in any way. For the sake of simplicity, not all possible combinations of the technical features in the above embodiments are described, however, as long as there is no contradiction in the combination of these technical features, they should be considered within the scope of this disclosure.

The above embodiments only express several ways of implementing the present application, and the description is relatively specific and detailed, but it should not be understood as a limitation on the scope of the invention patent. It should be noted that for ordinary technicians in the field, within the premise of not departing from the concept of the present application, several deformations and improvements can still be made, all of which belong to the scope of protection of the present application. Therefore, the scope of protection of the invention patent of the present application should be subject to the appended claims.

What is claimed is:

1. A device processing method, executed by a computer device, wherein the method comprises:
when obtaining device configuration recommendation information for a device under a target space, pushing and displaying the device configuration recommendation information;
wherein the device configuration recommendation information is obtained by analyzing a historical device operation data;
responding to a selection operation for at least one device configuration item in the device configuration recommendation information, displaying device control information corresponding to a selected target device configuration item;
responding to a configuration operation for the selected target device configuration item, performing configuration processing on a corresponding device based on a target device configuration item, to apply the target device configuration item.

2. The method according to claim 1, wherein the responding to the configuration operation for the selected target device configuration item, performing configuration processing on the corresponding device based on the target device configuration item, comprises:
receiving an update operation for the selected target device configuration item, and updating the device configuration item according to the update operation;
responding to a confirmation operation for an updated selected target device configuration item, performing configuration processing on the corresponding device based on the target device configuration item.

3. The method according to claim 1, wherein the historical device operation data comprises: control operations of devices under the target space and execution parameters of the control operations within a target time period, and the device configuration recommendation information is obtained by:
analyzing the control operations and execution parameters of the control operations of the devices under the target space within the target time period to obtain the device configuration recommendation information.

4. The method according to claim 3, wherein analyzing the control operations and execution parameters of the control operations of the devices under the target space within the target time period to obtain the device configuration recommendation information comprises:
for each control operation of the devices under the target space within the target time period, when execution frequency of the control operation within the target time period is greater than or equal to a frequency threshold, determining the control operation as a pending analysis control operation;
analyzing execution parameters of pending analysis control operations, to obtain a target control operation and a target execution parameter corresponding to the target control operation;
based on the target control operation and the target execution parameter corresponding to the target control operation, obtaining the device configuration recommendation information.

5. The method according to claim 4, wherein the execution parameter comprises an execution time, and analyzing the execution parameters of the pending analysis control operations, to obtain the target control operation and the target execution parameter corresponding to the target control operation comprises:
obtaining an expected time of the execution times of the pending analysis control operations;
calculating differences between the expected time and the execution times of all the pending analysis control operations;
when the number of differences less than a preset time difference accounts for a proportion greater than or equal to a preset proportion threshold of the total number of differences, determining the expected time of the execution times of the pending analysis control operations as target execution time corresponding to the target control operation.

6. The method according to claim 1, wherein the device configuration recommendation information is also obtained by:
obtaining a user habit data within the target time period;
analyzing correlation between the user habit data and the control operations of the devices under the target space, as well as the execution parameters of the control operations within the target time period, to determine the device configuration recommendation information corresponding to the user habit data.

7. The method according to claim 1, wherein before pushing and displaying the device configuration recommendation information when obtaining the configuration recommendation information for the device under the target space, the method further comprises:
after completing a voice interaction, detecting whether there are any unread device configuration items currently;
when there are an unread device configuration item, outputting voice prompt information, wherein the voice prompt information is configured to remind a user to view the unread device configuration item.

8. The method according to claim 1, wherein the device configuration recommendation information comprises a scene configuration plan for a target scene;
before when obtaining the device configuration recommendation information for the device under the target space, pushing and displaying the device configuration recommendation information, the method comprises:
obtaining the historical device operation data, wherein the historical device operation data records at least operating attribute of the device; wherein the operating attribute is used to indicate at least one of an action performed by the device, a state after the device performs the action, and a time when the device performs the action;
determining device configuration requirement for the target scene based on the operating attribute of the device recorded in the historical device operation data; the device configuration requirement is used to indicate that at least one device needs to configure corresponding action in the target scene;
generating the scene configuration plan for the target scene according to the device configuration requirement, so that at least one device performs corresponding action configured according to the scene configuration plan in the target scene, when the target scene is executed.

9. The method according to claim 8, wherein determining the device configuration requirement for the target scene based on the operating attribute of the device recorded in the historical device operation data, comprises:
based on the operating attribute of the device recorded in the historical device operation data, determining whether at least one device have performed a new action after the execution of a configured target scene; wherein the new action is different from an action configured for the device in a configured target scene;
when yes, then act at least one new action performed by the device as device configuration requirement for the configured target scene, to indicate that at least one device needs to reconfigure the new action in the configured target scene.

10. The method according to claim 9, wherein based on the operating attribute of the device recorded in the historical device operation data, determining whether at least one device have performed the new action after the execution of the configured target scene, comprises:
when based on the operating attribute of the device recorded in the historical device operation data, determining that frequency of the device performing the new action within a first preset duration exceeds a preset frequency threshold, then determining that there is one device performed the new action; the first preset duration refers to time period during which the configured target scene is executed multiple times consecutively;
when based on the operating attribute of the device recorded in the historical device operation data, determining that the number of devices performing the new action after the execution of the configured target scene exceeds a quantity threshold, then determining that multiple devices have performed the new action.

11. The method according to claim 8, wherein generating the scene configuration plan for the target scene based on the device configuration requirements comprises:
creating the scene configuration attribute for the device in the target scene, according to the action that the device needs to configure in the target scene as indicated by the device configuration requirement, the scene configuration attribute indicating at least the action configured for the device in the target scene; generating the scene configuration plan based on the scene configuration attributes that have been created for each device in the target scene; or
obtaining the scene configuration attribute that have been created for the device in the target scene; adjusting the scene configuration attribute for the device in the target scene, based on the action that the device needs to configure in the target scene as indicated by the device configuration requirement; generating the scene configuration plan based on adjusted scene configuration attributes for each device in the target scene.

12. The method according to claim 1, wherein the device configuration recommendation information comprises a device control command corresponding to a target scene;
after performing configuration processing on the corresponding device based on the target device configuration item, to apply the target device configuration item, the method further comprises:
obtaining a first device parameter of a configured target scene, wherein the first device parameter is generated when the smart device executing an initial action configured in the target scene;
obtaining a scene steady-state set of the configured target scene, wherein the scene steady-state set comprises second device parameters generated during multiple scene observation periods; wherein each second device parameter is generated when the smart device executing an additional action during a single scene observation period;
updating the device control command when a target scene is triggered based on the first device parameter and the second device parameters in the scene steady-state set; wherein the device control command is used to indicate the smart device to execute corresponding initial action.

13. The method according to claim 12, wherein updating the device control command when the target scene is triggered based on the first device parameter and the second device parameters in the scene steady-state set comprises:
performing feature processing on an environmental parameter when the target scene is triggered, to obtain an environmental state corresponding to the target scene;
clustering the second device parameters in the scene steady-state set according to an obtained environmental state to obtain a third device parameter for corresponding environmental state; wherein the third device parameter is related to the action expected to be executed by the smart device in the corresponding environmental state;
updating the device control command when the target scene is triggered based on the third device parameter for the corresponding environmental state and the first device parameter.

14. The method according to claim 13, wherein updating the device control command when the target scene is triggered based on the third device parameter for the corresponding environmental state and the first device parameter comprises:
comparing the differences between the third device parameter and the first device parameter under the corresponding environmental state to obtain a comparison result;
updating the device control command when the target scene is triggered based on the comparison result.

15. The method according to claim 13, before updating the device control command when the target scene is triggered based on the third device parameter for the corresponding environmental state and the first device parameter, the method further comprises:
determining confidence level corresponding to the third device parameter under the corresponding environmental state; wherein the confidence level is determined based on number of times the third device parameter appears within a preset time period, or a ratio between the number of times the third device parameter appears within the preset time period and number of times the target scene is triggered;
when the confidence level meets the preset condition, then updating the device control command when the target scene is triggered based on the third device parameter for the corresponding environmental state and the first device parameter.

16. The method according to claim 13, wherein clustering the second device parameters in the scene steady-state set according to the obtained environmental state to obtain the third device parameter for the corresponding environmental state, comprises:
when there are multiple environmental states corresponding to the target scene, determining the scene steady-state sets for various environmental states;
for each environmental state, clustering the second device parameters in determined scene steady-state sets to obtain the third device parameter for the corresponding environmental state.

17. The method according to claim 16, after for each environmental state, clustering the second device parameters in determined scene steady-state sets to obtain the third device parameter for the corresponding environmental state, the method further comprises:
detecting whether third device parameters under various environmental states are the same;
when not, then pushing a new scene based on the third device parameters under various environmental states, or creating the new scene based on the third device parameters under various environmental states.

18. The method according to claim 1, wherein the device configuration recommendation information comprises device control command corresponding to the target scene;
after performing the configuration processing on the corresponding device based on the target device configuration item, to apply the target device configuration item, the method further comprises:
displaying an instruction optimization data for the target scene, wherein the instruction optimization data is used to indicate an updated device control command; the updated device control command is determined by the control terminal based on a first device parameter of the target scene and second device parameters in a scene steady-state set; the first device parameter is generated by the smart device executing an initial action configured in the target scene, indicating a device state of the smart device; wherein the scene steady-state set comprises the second device parameters generated during multiple scene observation periods;
each second device parameter is generated by the smart device an executing additional action during a single scene observation period;
sending a confirmation message to the control terminal in responding to a confirmation operation triggered by the instruction optimization data, so that the control terminal updates the device control command when the target scene is triggered.

19. A computer device, comprising at least one memory and at least one processor, the memory storing computer-readable instructions, the computer-readable instructions is configured to be executed by the processor, and cause the computer device to perform the method of claim 1.

20. A computer-readable storage medium, storing computer-readable instructions, the computer-readable instructions is configured to be executed by one or more processors, and cause the one or more processors to perform the method of claim 1.
